(19) United States
(12) Patent Application Publication
(10) Pub. No.: US 2022/0144087 A1
(43) Pub. Date: May 12, 2022

(54) DISPLAY CONTROL DEVICE AND DISPLAY CONTROL PROGRAM PRODUCT

(71) Applicant: DENSO CORPORATION, Kariya-city (JP)

(72) Inventors: Daisuke TAKEMORI, Kariya-city (JP); Akihiko YAGYU, Kariya-city (JP); Yasuhiro SHIMIZU, Kariya-city (JP); Kazuki KOJIMA, Kariya-city (JP); Shiori MANEYAMA, Kariya-city (JP)

(21) Appl. No.: 17/579,582

(22) Filed: Jan. 19, 2022

Related U.S. Application Data
(63) Continuation of application No. PCT/JP2020/026404, filed on Jul. 6, 2020.

(30) Foreign Application Priority Data
Jul. 24, 2019 (JP) 2019-136456
Apr. 28, 2020 (JP) 2020-079730

(51) Int. Cl. B60K 35/00

(52) U.S. Cl. CPC B60K 35/00; B60K 2370/1529; B60K 2370/1868; B60Y 2400/92; B60K 2370/52; B60Y 2300/12; B60K 2370/175

(57) ABSTRACT

In a display control device for a head-up display mounted in a vehicle, when a lane keeping control function of driving a vehicle to travel in a traveling lane is terminated, a termination notification image to notify a driver of a termination of the lane keeping control function is generated and caused to be displayed by the head-up display. As another example, in a configuration where the operation of the lane keeping control function is continued even when one of a right road line and a left road line of the traveling lane is not detected, a continuation notification image to notify a driver of a continuation of the lane keeping control function is generated and caused to be displayed by the head-up display.

### CROSS REFERENCE TO RELATED APPLICATIONS

The present application is a continuation application of International Patent Application No. PCT/JP2020/026404 filed on Jul. 6, 2020, which designated the U.S. and claims the benefit of priority from Japanese Patent Application No. 2019-136456 filed on Jul. 24, 2019 and Japanese Patent Application No. 2020-079730 filed on Apr. 28, 2020. The entire disclosures of all of the above applications are incorporated herein by reference.

### TECHNICAL FIELD

The present disclosure relates to a display control device and a display control program product for controlling a head-up display.

### BACKGROUND

Various techniques for controlling the display of a head-up display mounted on a vehicle have been proposed. For example, there is a travel control device that causes a display device such as a head-up display to display a guidance display of a lane change when guiding a vehicle to automatically change lanes.

### SUMMARY

The present disclosure describes a display control device and a display control program product capable of improving the convenience of a driver in a lane keeping control function of a vehicle equipped with a head-up display.

In an aspect of the present disclosure, when a lane keeping control function of driving a vehicle to travel in a traveling lane is terminated, a termination notification image to notify a driver of a termination of the lane keeping control function may be generated and caused to be displayed by the head-up display.

In an aspect of the present disclosure, in a configuration where an operation of a lane keeping control function of driving a vehicle to travel in a traveling lane is continued even when one of a right road line and a left road line of the traveling lane on which the vehicle is traveling is not detected, a continuation notification image to notify a driver of a continuation of the lane keeping control function may be generated and caused to be displayed by the head-up display.

### BRIEF DESCRIPTION OF DRAWINGS

Features and advantages of the present disclosure will become more apparent from the following detailed description made with reference to the accompanying drawings.

FIG. 1 is a diagram showing an in-vehicle system according to a first embodiment of the present disclosure.

FIG. 2 is a diagram showing an example of a head-up display device installed in a vehicle.

FIG. 3 is a diagram showing a functional configuration of the display control device.

FIG. 4 is a flowchart showing an example of processing executed by the display control device.

FIG. 5 is a flowchart showing an example of processing executed by the display control device.

FIG. 6 is a flowchart showing an example of processing executed by the display control device.

FIG. 7 is a flowchart showing an example of processing executed by the display control device.

FIG. 8 is a flowchart showing an example of an image generation process.

FIG. 9 is a flowchart showing an example of a virtual area specifying process.

FIG. 10 is a diagram showing a plan view of an example of a virtual three-dimensional space.

FIG. 11 is a diagram showing a state in which an image generated using the virtual three-dimensional space shown in FIG. 10 is projected.

FIG. 12 is a diagram showing a plan view of another example of a virtual three-dimensional space.

FIG. 13 is a diagram showing a state in which an image generated based on the virtual three-dimensional space shown in FIG. 12 is projected.

FIG. 14 is a diagram showing a plan view of still another example of a virtual three-dimensional space.

FIG. 15 is a diagram showing a state in which an image generated based on the virtual three-dimensional space shown in FIG. 14 is projected.

FIG. 16 is a diagram showing a state in which an example of an image showing an undetected position of a road line is projected.

FIG. 17 is a diagram showing a plan view of yet another example of a virtual three-dimensional space.

FIG. 18 is a diagram showing a state in which an image generated based on the virtual three-dimensional space shown in FIG. 17 is projected.

FIG. 19 is a diagram showing a state in which an image showing a remaining time until a lane keeping control function is terminated is projected.

FIG. 20 is a diagram showing a state in which an image including only an image content associated with a detected road line is projected.

FIG. 21 is a diagram showing a plan view of further another example of a virtual three-dimensional space.

FIG. 22 is a diagram showing a state in which an image generated based on the virtual three-dimensional space shown in FIG. 21 is projected.

FIG. 23 is a diagram showing a state in which an image including an image content for urging a driver to grasp a steering wheel is projected.

FIG. 24 is a diagram showing a plan view of further another example of a virtual three-dimensional space.

FIG. 25 is a diagram showing a state in which an image generated based on the virtual three-dimensional space shown in FIG. 24 is projected.

FIG. 26 is a diagram showing a plan view of further another example of a virtual three-dimensional space.

FIG. 27 is a diagram showing a state in which an image generated based on the virtual three-dimensional space shown in FIG. 26 is projected.

FIG. 28 is a diagram showing an image content projected when road lines on both sides are detected in a second embodiment of the present embodiment.

FIG. 29 is a diagram showing an image content projected when an undetected position exists outside an angle of view.

FIG. 30 is a diagram showing a plan view of an example of a virtual three-dimensional space according to the second embodiment.

FIG. 31 is a diagram showing an example of image content projected when an undetected position exists within the angle of view.

FIG. 32 is a diagram showing another example of an image content projected when an undetected position exists within the angle of view.

FIG. 33 is a diagram showing an image content projected when the road line only on one side is detected.

FIG. 34 is a diagram showing an image content projected when a lane keeping control is terminated.

FIG. 35 is a diagram showing an example of an image content projected when a detection position is within the angle of view.

FIG. 36 is a diagram showing another example of an image content projected when the detection position is within the angle of view.

FIG. 37 is a diagram showing an example of a scene in which a road line on one side is temporarily not detected.

FIG. 38 is a diagram showing an example of an image content projected in the scene shown in FIG. 37.

FIG. 39 is a diagram showing an example of a display transition of an LTA status displayed on a meter display in the scene shown in FIG. 37.

FIG. 40 is a diagram showing an example of a scene in which a road line on one side is not detected during execution of an offset control.

FIG. 41 is a diagram showing an example of an image content projected in the scene shown in FIG. 40.

FIG. 42 is a diagram showing an example of an image content projected after the display shown in FIG. 41.

FIG. 43 is a diagram showing another example of an image content projected after the display shown in FIG. 41.

### DETAILED DESCRIPTION

In recent years, a lane keeping control function for keeping a vehicle to travel in a traveling lane has been put into practical use. Some lane keeping control functions are executed when two road lines on both sides of a traveling lane are detected, and are automatically terminated when one of the two road lines cannot be detected any more.

However, in a travel control device that causes a display device to display a guidance display of a lane change, it may be difficult to notify a driver in advance of an operation state of the lane keeping control function. In such a case, the convenience of the driver is low.

The present disclosure provides a display control device and a display control program product capable of improving the convenience of a driver in a lane keeping control function of a vehicle equipped with a head-up display.

According to a first aspect of the present disclosure, a display control device is for controlling a display of a head-up display installed in a vehicle, and includes: an image generation unit that generates an image to be displayed by the head-up display; and a display control unit that provides the image generated by the image generation unit to the head-up display and causes the head-up display to display the image. In a case where a lane keeping control function of driving the vehicle to travel in a traveling lane is terminated, the image generation unit generates a termination notification image to notify a driver of a termination of the lane keeping control function, and the display control unit provides the termination notification image to the head-up display and causes the head-up display to display the termination notification image.

According to a second aspect of the present disclosure, a display control program product for controlling a display by a head-up display mounted on a vehicle is stored in a computer-readable non-transitory tangible storage medium, and includes instructions to be executed by one or more processors. The instructions include: generating a termination notification image to notify a driver of a termination of a lane keeping control function of driving the vehicle to travel in a traveling lane; providing the termination notification image to the head-up display; and causing the head-up display to display the termination notification image.

According to the first and second aspects, when the lane keeping control function is terminated, the termination notification image for notifying the driver of the termination of the lane keeping control function is generated. Then, the termination notification image is displayed in front of the driver by the head-up display. Therefore, the driver can understand the termination of the lane keeping control function when visually recognizing the termination notification image displayed. In this way, by notifying the driver in advance of an operation state of the lane keeping control function, it is possible to improve the convenience of the driver.

According to a third aspect of the present disclosure, a display control device is for controlling a display by a head-up display mounted in a vehicle, and includes: an image generation unit that generates an image to be displayed by the head-up display; and a display control unit that provides the image generated by the image generation unit to the head-up display and causes the head-up display to display the image. In a configuration where an operation of a lane keeping control function of driving the vehicle to travel in a traveling lane is continued even when one of a right road line and a left road line of the traveling lane on which the vehicle is traveling is not detected, the image generation unit generates a continuation notification image to notify the driver of a continuation of the lane keeping control function. The display control unit provides the continuation notification image to the head-up display and causes the head-up display to display the continuation notification image.

According to a fourth aspect of the present disclosure, a display control program product for controlling a display by a head-up display mounted on a vehicle is stored in a computer-readable non-transitory tangible storage medium, and includes instructions to be executed by one or more processors. The instructions include: in response to an operation of a lane keeping control function of driving the vehicle to travel in a traveling lane being continued even when one of a right road line and a left road line of the traveling lane on which the vehicle is traveling is not detected, generating a continuation notification image to notify the driver of a continuation of the lane keeping control function; providing the continuation notification image to the head-up display; and causing the head-up display to display the continuation notification image.

According to the third and fourth aspects, in the configuration where the lane keeping control function for driving the vehicle in the traveling lane is continued even if one of the left road line and the right road line of the traveling lane is not detected, the continuation notification image to notify the driver of the continuation of the lane keeping control function is generated. Then, the continuation notification image is displayed in front of the driver by the head-up display. Therefore, even if one of the lane lines is deleted, the driver can understand the continuation of the lane keeping control function by visually recognizing the continuation notification image. In this way, by notifying the driver in advance of the operation state of the lane keeping control function, it is possible to improve the convenience of the driver.

### First Embodiment

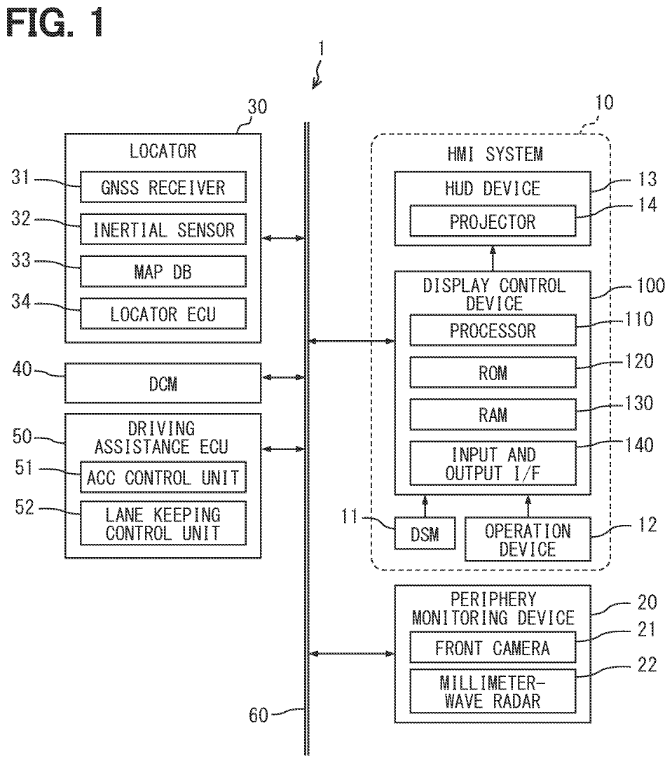

Hereinafter, a first embodiment of the present disclosure will be described with reference to FIGS. 1 to 27. An in-vehicle system 1 mainly includes a human machine interface (HMI) system 10. Further, the in-vehicle system 1 includes a periphery monitoring device 20, a locator 30, a data communication module (DCM) 40, and a driving assistance electronic control unit (ECU) 50. These nodes communicate data with each other via a communication bus 60. Of these devices and ECUs, specific nodes may be electrically, directly connected to each other to communicate with each other without passing through the communication bus 60.

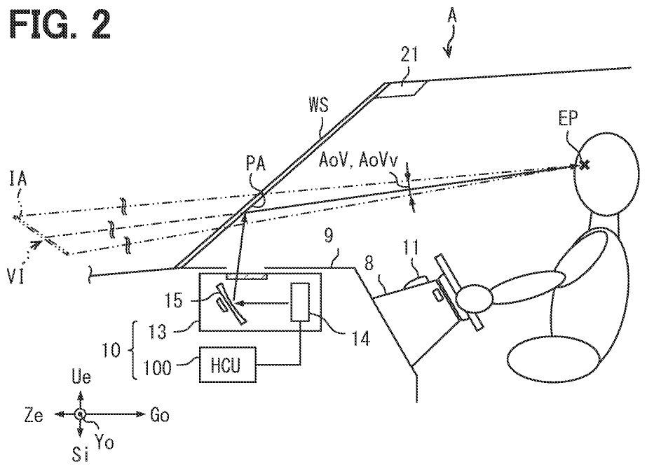

In the following description, a front-rear direction (see FIG. 2, Ze corresponding to forward, and Go corresponding to rearward) and a left-right direction (see FIG. 2, Yo corresponding to sideways) are defined with reference to the vehicle A motionlessly stationed on a horizontal plane. Specifically, the front-rear direction is defined along the longitudinal direction (traveling direction) of the vehicle A. The left-right direction is defined along a width direction of the vehicle A. Further, a vertical direction (see FIG. 2, Ue corresponding to upward and Si corresponding to downward) is defined along a direction vertical to the horizontal plane that defines the front-rear direction and the left-right direction. Further, for the sake of simplification of the description, the description of the reference numeral indicating each direction may be omitted as appropriate.

The periphery monitoring device 20 is a device that monitors the surrounding environment of a vehicle A, that is, a subject vehicle. The periphery monitoring device 20 includes a front camera 21 and a millimeter wave radar 22. The front camera 21 photographs an area in front of the vehicle A to generate a photographed image, and transmits the photographed image to the driving assistance ECU 50 and a display control device 100 of the HMI system 10 via the communication bus 60. The millimeter wave radar 22 uses millimeter waves or quasi-millimeter waves to calculate the distance to an object around the vehicle A, and the relative speed and orientation of the object, and transmits the information to the driving assistance ECU 50 via the communication bus 60.

The locator 30 is a device that generates position information of the vehicle A. The locator 30 includes a global navigation satellite system (GNSS) receiver 31, an inertial sensor 32, a map database (hereinafter referred to as a map DB) 33, and a locator ECU 34.

The GNSS receiver 31 is a device that receives positioning signals transmitted from a plurality of positioning satellites. The GNSS receiver 31 can use satellite positioning systems such as GPS, GLONASS, Galileo, IRNSS, QZSS, and Beidou.

The inertia sensor 32 is a device that detects the acceleration and the angular velocity of the vehicle A. Specific examples of the inertial sensor 32 include an acceleration sensor, a gyro sensor, and the like.

The map DB 33 is a storage device in which map information for conventional navigation or map information having higher accuracy than the map information (hereinafter referred to as high-precision map information) is recorded. The high-precision map information includes information that can be used for advanced driving support, such as information indicating the three-dimensional shape of a road, information on the position of a road line, information on the number of lanes, and information indicating the traveling direction of each lane.

The locator ECU 34 includes a microcomputer provided with a processor, a read only memory (ROM), a random access memory (RAM), and an input/output interface. The locator ECU 34 can generate speed information of the vehicle A based on a detection signal of a wheel speed sensor provided in a hub portion of each wheel of the vehicle A. The locator ECU 34 can sequentially calculate the position, traveling direction, and posture information (that is, roll, pitch, yaw) of the vehicle A by using the positioning signal received by the GNSS receiver 31, the detection result of the inertial sensor 32, and the speed information of the vehicle A.

The locator ECU 34 provides the calculated speed information, posture information, position information, and direction information of the vehicle A to other nodes through the communication bus 60. Further, when the locator ECU 34 receives a request for map information from another node, the locator ECU 34 provides the requested map information to the requesting node.

The DCM40 is a communication module mounted on the vehicle A. The DCM40 transmits and receives data to and from base stations in the vicinity of the vehicle A by wireless communication compliant with communication standards such as long term evolution (LTE) and 5G. The DCM40 can acquire the map information from a probe server having the latest map information via the Internet. The locator ECU 34 can update the map information stored in the map DB 33 by using the latest map information acquired by the DCM 40.

The driving assistance ECU 50 is an ECU that assists a driving operation of the driver. The driving assistance ECU 50 realizes partial automatic driving control of level 2 or lower at the automatic driving level specified by the American Society of Automotive Engineers of Japan. The driving assistance ECU 50 includes a microcomputer provided with a processor, a ROM, a RAM, and an input/output interface. The processor realizes an ACC (adaptive cruise control) control unit 51 and a lane keeping control unit 52 by executing the programs stored in the ROM.

The ACC control unit 51 is a functional unit that realizes functions of ACC. The ACC control unit 51 uses the photographed image and the detection information provided by the periphery monitoring device 20 to drive the vehicle A at the vehicle speed specified by the driver, or to drive the vehicle A following the vehicle in front while maintaining the distance between the vehicle A and the vehicle in front.

The lane keeping control unit 52 is a functional unit that realizes a lane keeping control function for driving the vehicle A in a traveling lane. The lane keeping control function realized by the lane keeping control unit 52 is known as a lane tracing assist (LTA) and a lane trace control (LTC).

The lane keeping control function has three states, such as an OFF state, a standby state, and an execution state. If the driver presses an activation switch of the lane keeping control function while the ACC function is in the execution state, the lane keeping control unit 52 analyzes the captured image provided by the front camera 21 and begins a detection process of detecting a road line of the traveling lane in front of and in front side areas of the vehicle A. That is, the lane keeping control function transitions from the OFF state to the standby state.

In the standby state of the lane keeping control function, when the lane keeping control unit 52 detects the road lines on both left and right sides of the traveling lane of the vehicle A. When the lane keeping control unit 52 recognizes the road lines on both the left and right sides of the traveling lane, the lane keeping control unit 52 controls the steering angle of a steering wheel of the vehicle A so as to drive the vehicle A in the traveling lane. That is, the lane keeping control function transitions from the standby state to the execution state.

In the execution state of the lane keeping control function, when the lane keeping control unit 52 detects the road line only on one side of the traveling lane of the vehicle A, the lane keeping control unit 52 terminates the lane keeping control within a predetermined time period. Thus, the lane keeping control function transitions from the execution state to the standby state or the OFF state. The predetermined time period can be various periods according to the speed of the vehicle A. For example, when the speed of the vehicle A is in a range of 60 km to 100 km, the predetermined time period can be 5 seconds or the like.

The lane keeping control unit 52 provides at least the display control device 100 with (1) status information indicating that the lane keeping control function is in the execution state. The lane keeping control unit 52 further provides the display control device 100 with (2) detection information indicating that the road lines on both sides of the traveling lane of the vehicle A are detected, and (3) detection information indicating that the road line only on one side of the traveling lane of the vehicle A is detected.

The HMI system 10 is a system that provides an interface between the vehicle A and the driver. The HMI system 10 includes a driver status monitor (DSM) 11, an operation device 12, a display control device 100, and a head-up display (HUD) device 13.

The DSM 11 includes a near-infrared light source and a near-infrared camera, and a control unit for controlling the near-infrared light source and the near-infrared camera. The DSM 11 is installed at a position so that the face of a driver seated on a driver's seat is irradiated with the near-infrared light of the near-infrared light source and the driver's face can be photographed by the near-infrared camera. For example, the DSM 11 can be installed on an upper surface of a steering column portion 8 shown in FIG. 2, on an upper surface of an instrument panel 9, or the like. The near-infrared camera captures the driver's face in a cycle of 30 fpm or the like and generates a captured image. The control unit analyzes the captured image, calculates a viewpoint position EP of the driver, and sequentially provides a viewpoint position information indicating the viewpoint position EP to the display control device 100.

The operation device 12 is a device capable of accepting an operation by the driver. Examples of the operation device 12 include a switching device for switching between starting and stopping of the ACC, a switching device for switching between starting and stopping of the lane keeping control function, and the like. The operation device 12 can be realized by a steering switch or the like provided on the spoke portion of the steering wheel.

The display control device 100 is a device that generates an image to be projected by the HUD device 13 and provides the image to the HUD device 13 for projection. Examples of the display control device 100 include a HMI control unit (hereinafter, also referred to as the HCU) and the like. The display control device 100 includes a microcomputer provided with at least one processor 110, a non-volatile storage device 120 such as a ROM, a volatile storage device 130 such as a RAM, and an input/output interface 140. The processor 110 is an arithmetic unit capable of executing various programs. The processor 110 includes at least one such as a central processing unit (CPU), a graphics processing unit (GPU), and a neural network processing unit (NPU). Various data such as programs are stored in the non-volatile storage device 120. The processor 110 executes a display control method of the present disclosure by accessing the non-volatile storage device 120 in which the display control program of the present disclosure is stored, loading the display control program in the volatile storage device 130, and executing the display control program. The processor 110 can communicate various data with other nodes via the input/output interface 140.

The HUD device 13 is a device that displays an image in front of the driver of the vehicle A. As shown in FIG. 2, the HUD device 13 is installed in an accommodation space provided in an instrument panel 9 below the windshield WS. The HUD device 13 includes a projector 14 and a magnifying optical system 15.

The projector 14 includes a liquid crystal display (LCD) panel and a backlight. The projector 14 is fixed in a position at which a display surface of the LCD panel facing the magnifying optical system 15. The projector 14 displays the image provided by the display control device 100 on the LCD panel. By illuminating the LCD panel with a backlight, the light forming the image is emitted to the magnifying optical system 15.

The magnifying optical system 15 includes a concave mirror in which a metal having light reflectivity is vapor-deposited on the surface of a base material. The magnifying optical system 15 reflects the emitted light from the projector 14 and projects the reflected light toward the windshield WS. The light projected toward the windshield WS is reflected in a projection area PA of the windshield WS, and the reflected light travels toward the driver's seat side and reaches the driver's pupil. As a result, the driver can visually recognize a virtual image VI of the image generated by the display control device 100 ahead of the windshield WS (front Ze).

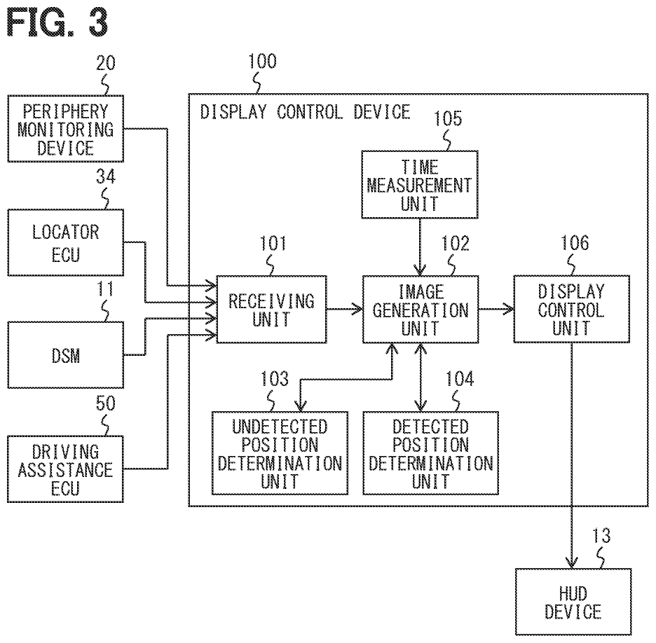

Next, the function of the display control device 100 will be described with reference to FIG. 3. The display control device 100 includes a receiving unit 101, an image generation unit 102, an undetected position determination unit 103, a detection position determination unit 104, a time measurement unit 105, and a display control unit 106.

The receiving unit 101 is a functional unit that receives information provided by the periphery monitoring device 20, the locator ECU 34, the DSM 11, and the driving assistance ECU 50. Upon receiving the captured image from the periphery monitoring device 20, the receiving unit 101 stores the captured image in the volatile storage device 130. Upon receiving information from the locator ECU 34 such as the map information, the position information of the vehicle A, the speed information, and the posture information, the receiving unit 101 stores the information in the volatile storage device 130. Upon receiving the viewpoint position information from the DSM 11, the receiving unit 101 stores the viewpoint position information in the volatile storage device 130. Upon receiving the status information of the lane keeping control function and various detection information from the driving assistance ECU 50, the receiving unit 101 notifies the image generation unit 102 of the reception of these information.

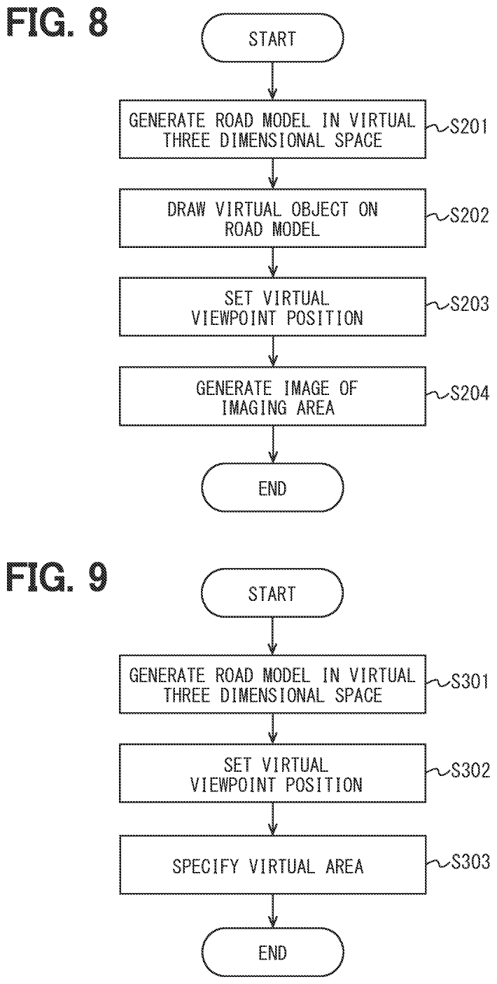

The image generation unit 102 is a functional unit that generates an image to be projected by the HUD device 13. The image generation unit 102 executes an image generation processing shown in FIG. 8 to generate the image to be projected by the HUD device 13.

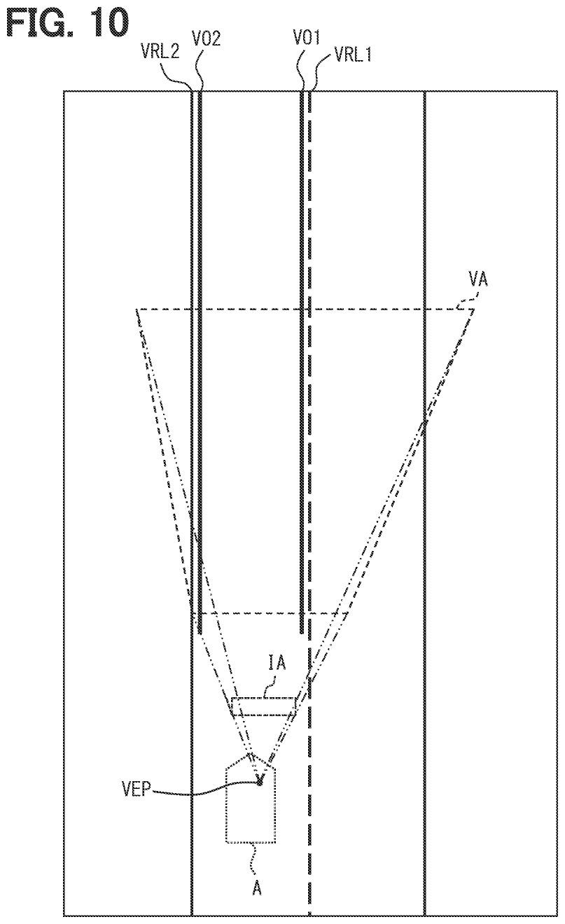

In the image generation processing, in S201, the image generation unit 102 acquires information (for example, the map information, the position information of the vehicle A, and the captured image and the like) necessary to generate a road model in a virtual three-dimensional space from the volatile storage device 130, and generates the road model in the virtual three-dimensional space. In S202, the image generation unit 102 draws a virtual object VO corresponding to a superimposition content displayed in association with an object in the foreground on the road model in the virtual three-dimensional space. For example, in a situation where the road lines on both sides of the traveling lane of the vehicle A are detected, the image generation unit 102 draws virtual objects VO1 and VO2 with solid lines along virtual road line VRL1 and VRL2 corresponding to the detected road lines for highlighting the road lines, as shown in FIG. 10. The image generation unit 102 can draw the virtual objects VO1 and VO2 inside the traveling lane defined by the virtual road lines VRL1 and VRL2, respectively. Alternatively, the image generation unit 102 may draw the virtual objects VO1 and VO2 on the outside of the traveling lane, respectively. As further another example, the image generation unit 102 may draw the virtual objects VO1 and VO2 on the virtual road lines VRL1 and VRL2, respectively.

In S203, the image generation unit 102 acquires the viewpoint position information from the volatile storage device 130, and sets a virtual viewpoint position VEP of the virtual three-dimensional space based on the viewpoint position information in the virtual three-dimensional space. The virtual viewpoint position VEP corresponds to the viewpoint position EP of the driver of the vehicle A.

In S204, the image generation unit 102 generates an image of an image forming area IA that is defined by the virtual viewpoint position VEP, the angle of view AoV, and the posture information of the vehicle A in the virtual three-dimensional space. The image forming area IA corresponds to the image forming area IA in which the HUD device 13 forms a virtual image VI in a real three-dimensional space. As shown in FIG. 2, the image forming area IA in the real three-dimensional space is defined by a virtual line extending from the viewpoint position EP at the angle of view AoV. Similarly, the image forming area IA of the virtual three-dimensional space is defined by a virtual line extending from the virtual viewpoint position VEP at the angle of view AoV. The image of the image forming area IA in the virtual three-dimensional space generated by the image generation unit 102 is imaged as a virtual image VI in the real three-dimensional space. In the present embodiment, as an example of the angle of view AoV, an angle of view with a horizontal angle of view AoVh of 10 degrees and a vertical angle of view AoVv of 4 degrees can be adopted. The horizontal angle of view AoVh is, for example, about 10 to 12 degrees, and the vertical angle of view AoVv is, for example, about 4 to 5 degrees.

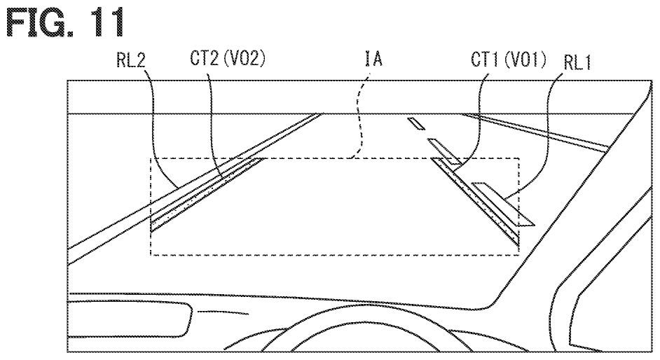

In the example shown in FIG. 10, the virtual objects VO1 and VO2 are drawn in the virtual area VA. The virtual area VA is an area on the road model defined by the virtual viewpoint position VEP, the angle of view AoV, and the posture information of the vehicle A. The virtual area VA is an area corresponding to a front range (for example, a range of about several ten meters to about 100 m) that overlaps with the image forming area IA when viewed from the viewpoint position EP. The image generation unit 102 can generate an image of the image forming area IA by performing perspective projection conversion of the virtual objects VO1 and VO2 drawn in the virtual area VA shown in FIG. 10. When the HUD device 13 projects this image toward the windshield WS, image contents CT1 and CT2 as shown in FIG. 11 are formed in the image forming area IA. The image contents CT1 and CT2 are superimposition contents displayed in association with the object in the foreground, and correspond to the virtual objects VO1 and VO2 in the virtual three-dimensional space, respectively. The image contents CT1 and CT2 are displayed in association with the road lines RL1 and RL2, respectively. The driver of the vehicle A can see the image contents CT1 and CT2 as being displayed along the road lines RL1 and RL2.

The undetected position determination unit 103 is a functional unit that determines whether or not an undetected position UDP corresponding to a position where the road line of the traveling lane of the vehicle A is no longer detected exists in the virtual area VA. The detection position determination unit 104 is a functional unit that determines whether or not a detection position DP that corresponds to the position where the undetected road line of the traveling lane of the vehicle A is detected again exists in the virtual area VA. The time measuring unit 105 is a functional unit that measures time. The display control unit 106 is a functional unit that transmits an image to be projected to the HUD device 13 and projects the image.

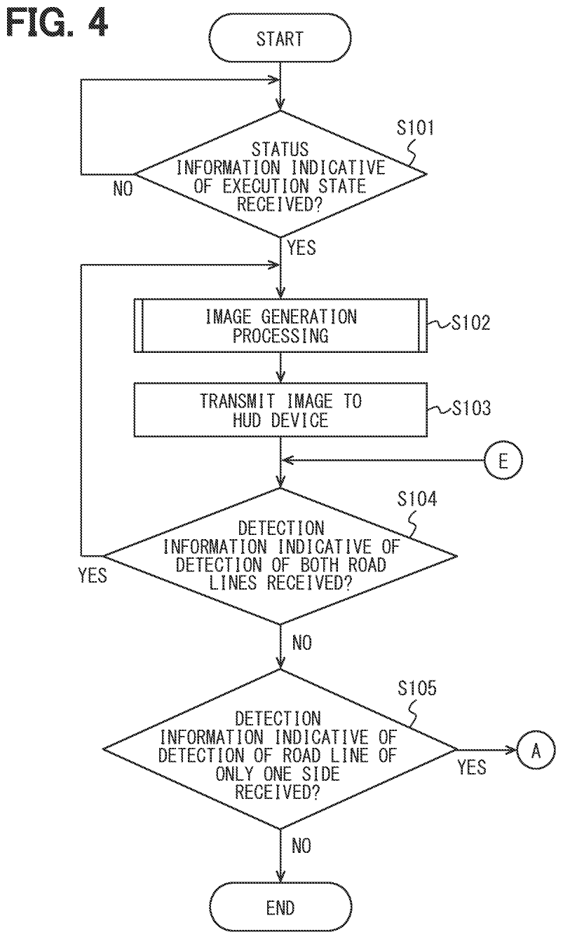

Next, an example of a processing executed by the display control device 100 will be described with reference to FIG. 4. In S101, it is determined whether or not the receiving unit 101 of the display control device 100 receives the status information indicating that the lane keeping control function is in the execution state. When the status information is not received (S101: NO), the process of S101 is executed again. On the other hand, when the status information is received (S101: YES), the processing branches to S102. In S102, the image generation unit 102 executes an image generation processing to generate an image as shown in FIG. 11.

In S103, the display control unit 106 transmits the image generated by the image generation processing in S102 to the HUD device 13. Upon receiving the image, the HUD device 13 projects the image toward the windshield WS. As a result, the image contents CT1 and CT2 as shown in FIG. 11 are imaged in the image forming area IA.

In S104, the receiving unit 101 determines whether or not the detection information indicating that the road lines on both sides of the traveling lane of the vehicle A are detected is received. When the detection information is received (S104: YES), the process returns to the process of S102. On the other hand, when the detection information is not received (S104: NO), the processing branches to S105.

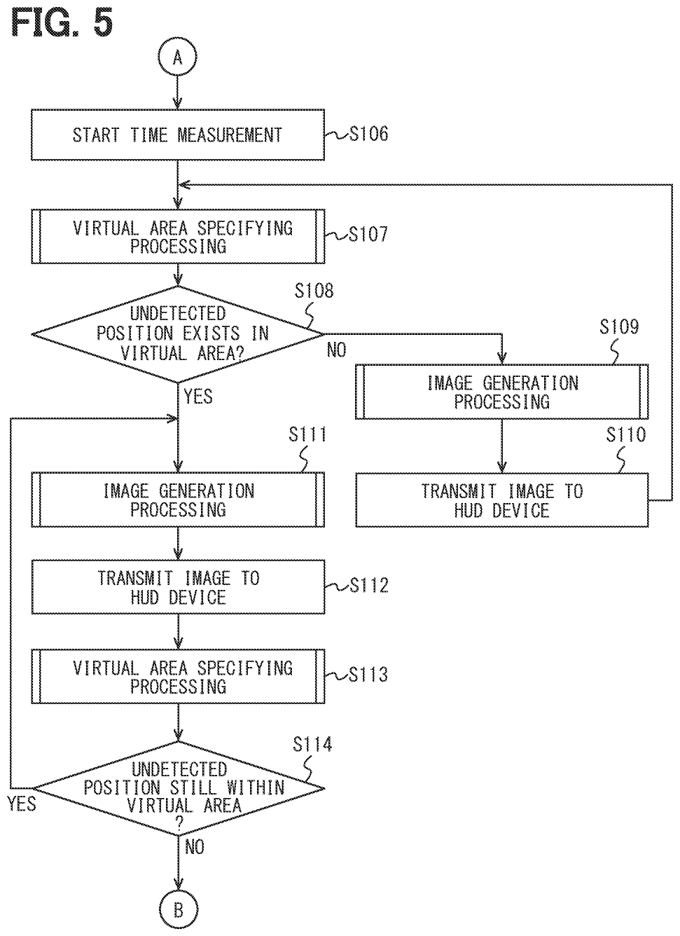

In S105, the receiving unit 101 determines whether or not the detection information indicating that the road line only on one side of the traveling lane of the vehicle A is detected is received. When the detection information is not received (S105: NO), the processing of FIG. 4 is ended. On the other hand, when the detection information is received (S105: YES), the processing branches to S106 in FIG. 5.

In S106, the time measurement unit 105 starts a time measurement. In S107, the image generation unit 102 executes a virtual area specifying processing to specify the virtual area VA. In the virtual area specifying processing shown in FIG. 9, in S301, the image generation unit 102 acquires the information necessary for generating the road model of the virtual three-dimensional space from the volatile storage device 130, and generates the road model in the virtual three-dimensional space. In S302, the image generation unit 102 acquires the viewpoint position information from the volatile storage device 130, calculates the virtual viewpoint position VEP in the virtual three-dimensional space using the viewpoint position information, and sets the calculated virtual viewpoint position VEP in the virtual three-dimensional space. In S303, the image generation unit 102 specifies the virtual area VA defined by the virtual viewpoint position VEP and the angle of view AoV.

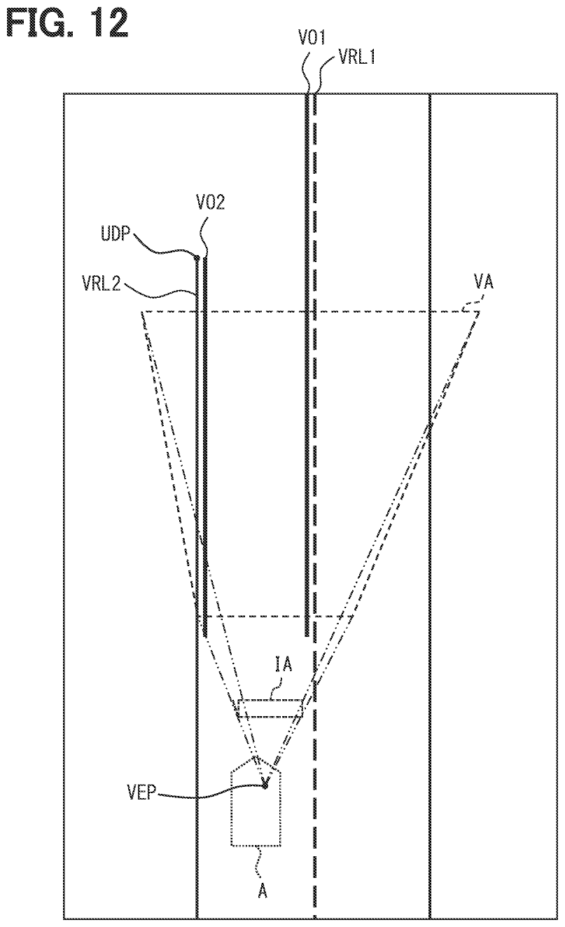

In S108, the undetected position determination unit 103 determines whether or not the undetected position UDP of the road line of the traveling lane of the vehicle A as shown in FIG. 12 exists in the virtual area VA specified in S107. When the undetected position UDP does not exist in the virtual area VA (S108: NO), the processing branches to S109.

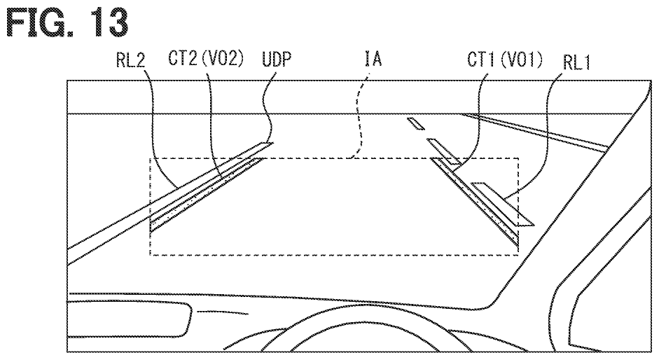

In S109, the image generation unit 102 executes an image generation processing to generate an image as shown in FIG. 13. At this time, in the image generation processing, the image generation unit 102 can draw the virtual objects VO1 and VO2 with solid lines along the virtual road lines VRL1 and VRL2, respectively, as shown in FIG. 12. The brightness of the drawing color can be the same between the virtual objects VO1 and VO2. Alternatively, the brightness of the drawing color of the virtual object VO2 of the road line that is no longer detected may be lower than that of the virtual object VO1 of the road line that is continuously detected.

In S110, the display control unit 106 transmits the image generated by the image generation processing in S109 to the HUD device 13. Upon receiving the image, the HUD device 13 projects the image toward the windshield WS. As a result, the image contents CT1 and CT2 as shown in FIG. 13 are imaged in the image forming area IA.

The image generation unit 102 generates an image so that the display mode of the image content CT1 of the road line RL1 continuously detected is constant. Also, the image generation unit 102 generates the image so that the display mode of the image content CT1 and the display mode of the image content CT2 of the road line RL2 that is no longer detected are different.

For example, the image content CT2 can be displayed to be blinked on the windshield WS. The image generation unit 102 generates an image in which both the virtual objects VO1 and VO2 are drawn, and the display control unit 106 transmits the image to the HUD device 13 for the projection. Thereafter, the image generation unit 102 generates an image in which only the virtual object VO1 is drawn, and the display control unit 106 transmits the image to the HUD device 13 for the projection. By repeatedly executing these processes, the image content CT2 is displayed blinking. On the other hand, the image content CT1 of the road line RL1 that is continuously detected is continuously displayed without blinking. That is, the image content CT1 is displayed in a certain display mode, and the image content CT1 and the image content CT2 are displayed in different display modes. The image shown in FIG. 13 corresponds to a termination notification image for notifying the driver of the termination of the lane keeping control function.

On the other hand, in S108, when it is determined that the undetected position UDP exists in the virtual area VA specified in S107 (S108: YES), the processing branches to S111.

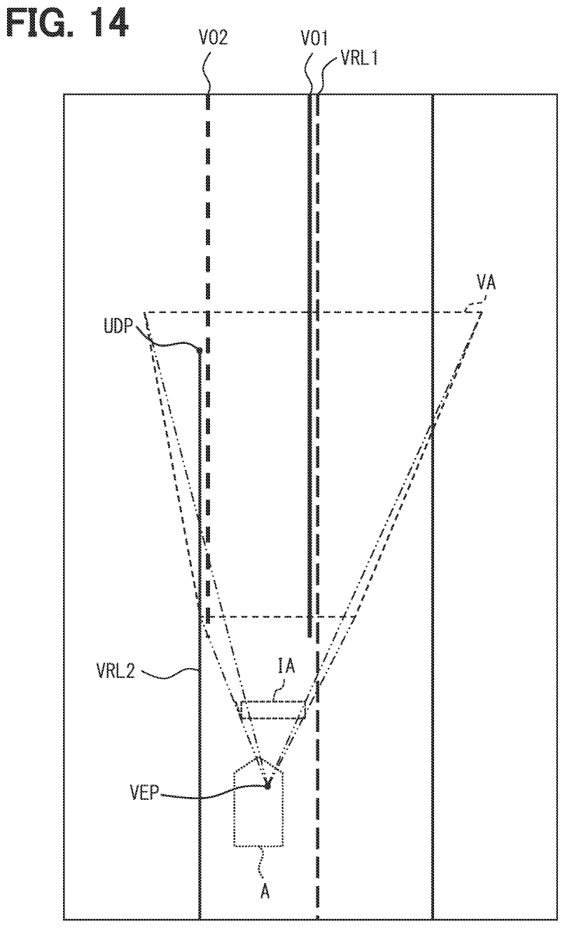

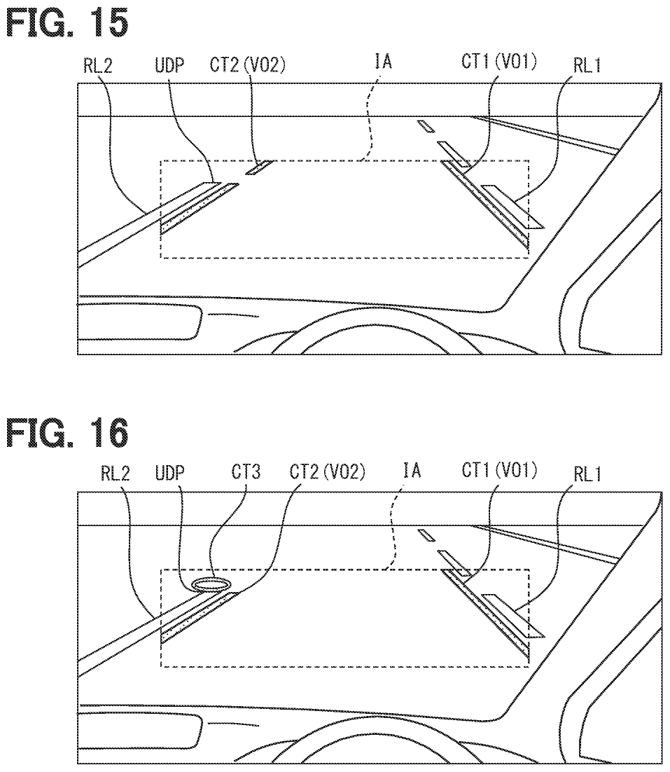

In S111, the image generation unit 102 executes an image generation processing to generate an image as shown in FIG. 15. In the image generation processing, as shown in FIG. 14, the image generation unit 102 draws the virtual object VO1 corresponding to the continuously detected road line with a solid line, and the virtual object VO2 corresponding to the road line that is no longer detected with a dotted line. At this time, the image generation unit 102 can draw the virtual objects VO1 and VO2 at positions offset from the detected virtual road line VRL1.

The offset amount differs depending on the virtual objects VO1 and VO2. The offset amount of the virtual object VO1 can be an arbitrary value so that the image content CT1 corresponding to the virtual object VO1 is displayed in the vicinity of the actual road line.

The offset amount of the virtual object VO2 can be determined based on a distance (hereinafter referred so as a standard distance) in the virtual three-dimensional space corresponding to the average road width (for example, 3 m). Specifically, in the case where the virtual objects VO1 and VO2 are drawn inside the traveling lane, the offset amount of the virtual object VO2 may be set by a difference obtained by subtracting the distance between the virtual road line VRL1 and the virtual object VO1 from the standard distance. In the case where the virtual objects VO1 and VO2 are drawn on the outside of the traveling lane, the offset amount of the virtual object VO2 may be the sum obtained by adding the distance between the virtual road line VRL1 and the virtual object VO1 and the standard distance. In the case where the virtual objects VO1 and VO2 are drawn on the road lines, the standard distance can be used as the offset amount of the virtual object VO2.

Further, the image generation unit 102 may draw both the virtual object VO1 and the virtual object VO2 with solid lines, and blink only the virtual object VO2. The brightness of the drawing color may be the same between the virtual objects VO1 and VO2. Alternatively, the brightness of the drawing color of the virtual object VO2 may be lower than that of the virtual object VO1. Further, the image generation unit 102 may draw a part of the virtual object VO2 with a solid line and draw the other part with a dotted line. Specifically, the virtual object VO2 between the vehicle A and the undetected position UDP can be drawn with a solid line, and the virtual object VO2 on a forward side, that is, a far side from the undetected position UDP with respect to the traveling direction of the vehicle A can be drawn with a dotted line.

In S112, the display control unit 106 transmits the image generated by the image generation processing in S111 to the HUD device 13. Upon receiving the image, the HUD device 13 projects the image toward the windshield WS. As a result, the image contents CT1 and CT2 as shown in FIG. 15 are imaged in the image forming area IA. The image shown in FIG. 15 corresponds to the termination notification image for notifying the termination of the lane keeping control function.

The image generation unit 102 may draw a virtual object indicating the undetected position UDP in the image generation processing in S111, and the display control unit 106 may transmit an image including this virtual object to the HUD device 13. Upon receiving the image, the HUD device 13 projects the image toward the windshield WS. As a result, the image contents CT1, CT2, and CT3 as shown in FIG. 16 are imaged in the image forming area IA. The image content CT3 is a superimposition content and corresponds to the virtual object. The image content CT3 is displayed in association with the undetected position UDP on the actual road surface. The image shown in FIG. 16 corresponds to the termination notification image for notifying the termination of the lane keeping control function.

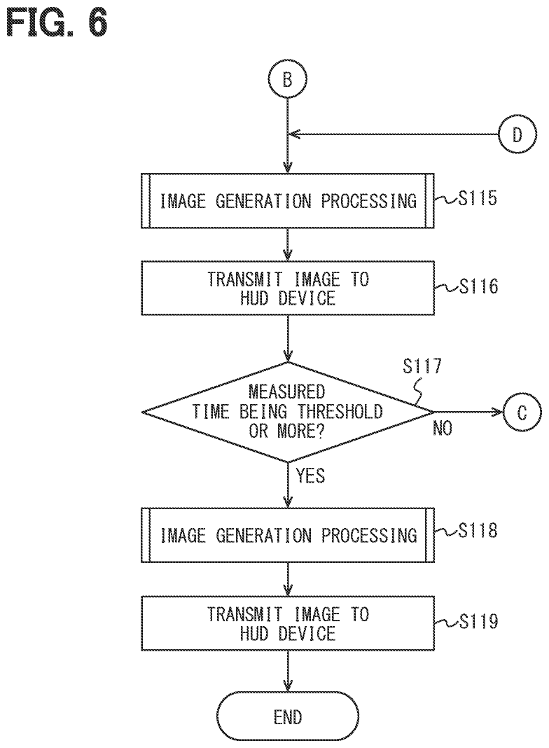

In S113, the image generation unit 102 executes the virtual area specifying processing to specify the virtual area VA. In S114, the undetected position determination unit 103 determines whether or not the undetected position UDP of the road line of the traveling lane of the vehicle A still exists in the virtual area VA specified in S113. When the undetected position UDP exists in the virtual area VA (S114: YES), the processing returns to S111. On the other hand, when the undetected position UDP does not exist in the virtual area VA (S114: NO), the processing branches to S115 shown in FIG. 6.

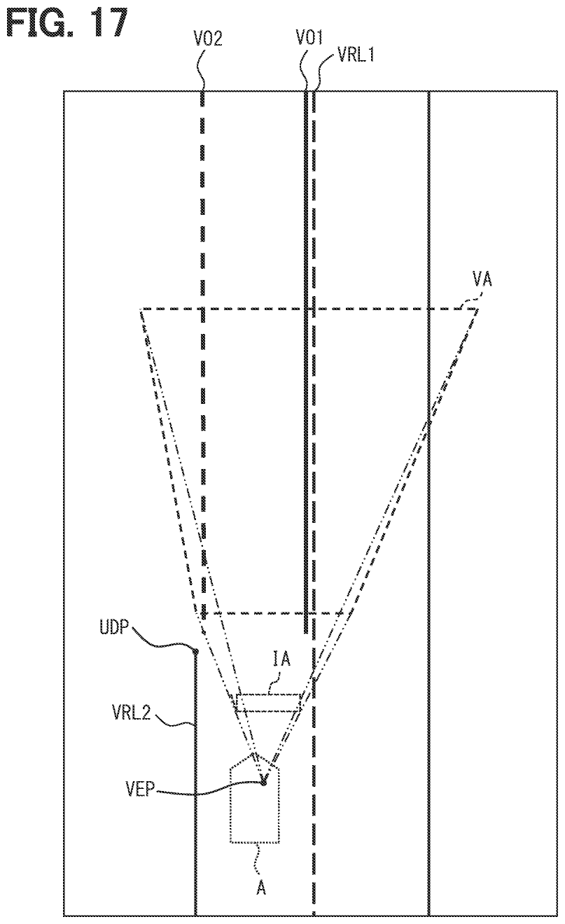

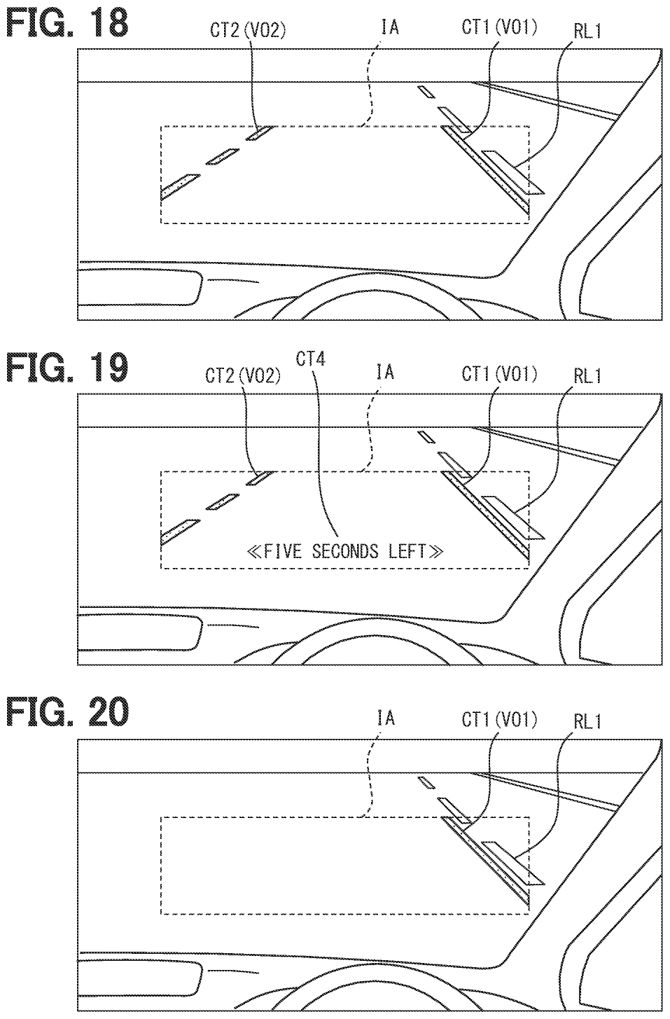

In S115, the image generation unit 102 executes an image generation processing to generate an image as shown in FIG. 18. In the image generation processing, as shown in FIG. 17, the image generation unit 102 draws the virtual object VO1 of the road line, which is continuously detected, with a solid line, and draws the virtual object VO2 of the road line, which is undetected, with a dotted line. The brightness of the drawing color may be the same between the virtual objects VO1 and VO2. Alternatively, the brightness of the drawing color of the virtual object VO2 may be lower than that of the virtual object VO1.

In S116, the display control unit 106 transmits the image generated by the image generation processing in S115 to the HUD device 13. Upon receiving the image, the HUD device 13 projects the image toward the windshield WS. As a result, the image contents CT1 and CT2 as shown in FIG. 18 are imaged in the image forming area IA. The image shown in FIG. 18 corresponds to the termination notification image for notifying the termination of the lane keeping control function.

The image generation unit 102 may synthesize the image generated by the image generation processing in S115 and an image content CT4 indicating a remaining time to the termination of the lane keeping control function (FIG. 19). The remaining time to the termination of the lane keeping control function can be calculated by the image generation unit 102 by using the measurement time of the time measurement unit 105. For example, when a predetermined time period to the time the lane keeping control function is terminated is 5 seconds, the image generation unit 102 sets the value obtained by subtracting the measurement time from 5 seconds as the remaining time to the termination of the lane keeping control function.

Then, the display control unit 106 transmits the composite image of the image generated by the image generation processing in S115 and the image of the image content CT4 to the HUD device 13, and the HUD device 13 projects the composite image toward the windshield WS. As a result, as shown in FIG. 19, the image contents CT1, CT2, and CT4 are imaged in the image forming area IA. The image content CT4 is a non-superimposition content and is displayed at a predetermined position in the image forming area IA without being associated with an object in the foreground. The image shown in FIG. 19 corresponds to the termination notification image for notifying the termination of the lane keeping control function.

In the image generation processing in S115, the image generation unit 102 may draw only the virtual object VO1 of the continuously detected road line with the solid line, and may not draw the virtual object of the road line that is no longer detected. In this case, as shown in FIG. 20, the image content CT1 is imaged in the image forming area IA. The image shown in FIG. 20 corresponds to the termination notification image for notifying the termination of the lane keeping control function.

In S117, the image generation unit 102 determines whether or not the measurement time by the time measurement unit 105 is equal to or longer than a threshold value. The threshold value corresponds to a predetermined time period from the time when the display control device 100 receives the detection information indicating that the road line is detected only on one side to the time when the lane keeping control function is terminated. The threshold value can be a time period according to the speed of the vehicle A. For example, when the speed of the vehicle A is in a range of 60 to 100 km, the threshold value may be 5 seconds or the like.

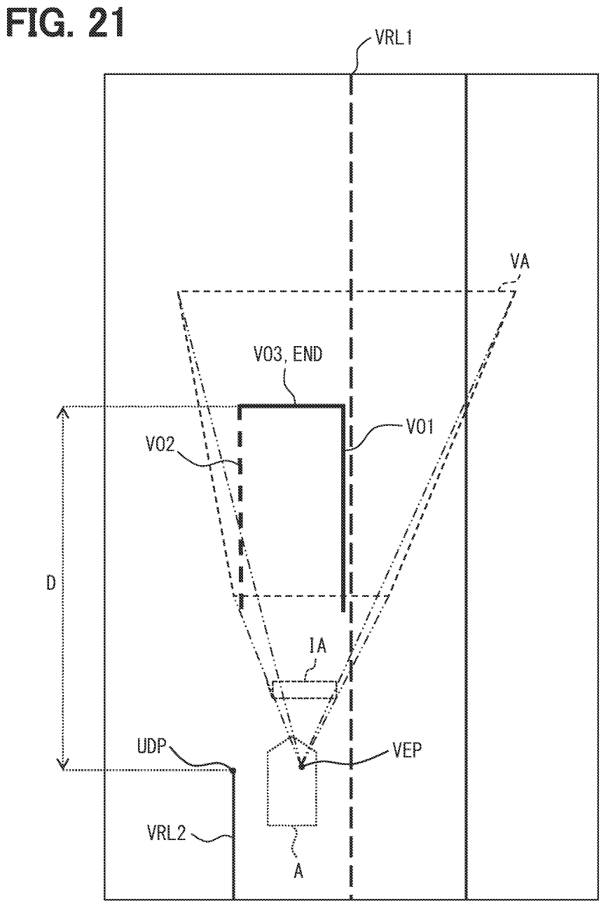

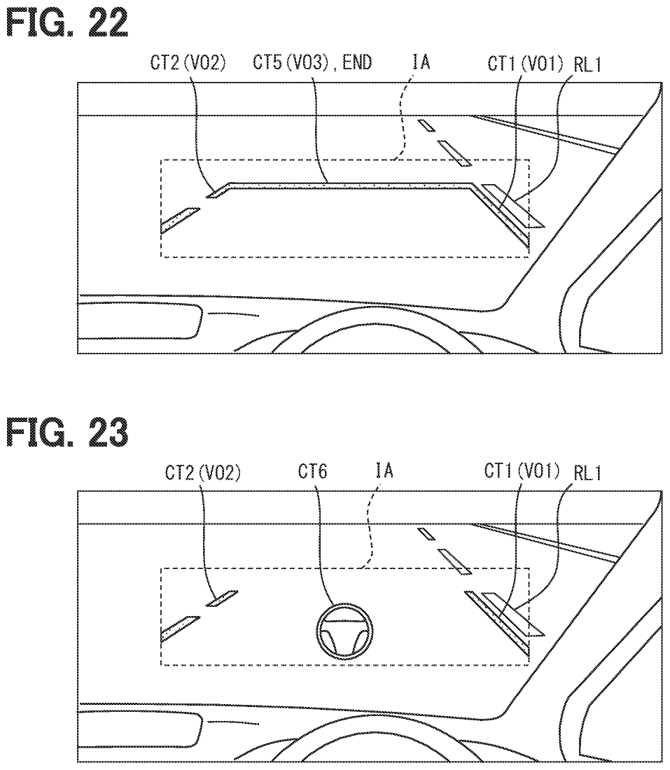

When the measurement time period is equal to or longer than the threshold value (S117: YES), the processing branches to S118. In S118, the image generation unit 102 executes an image generation processing to generate an image as shown in FIG. 22. In the image generation processing, as shown in FIG. 21, the image generation unit 102 draws the virtual object VO1 of the road line continuously detected and a virtual object VO3 indicating the termination position END of the lane keeping control function with the solid line. Further, the image generation unit 102 can draw the virtual object VO2 of the undetected road line with a dotted line. In this case, the image generation unit 102 draws the virtual object VO2 with the dotted line up to the termination position END. The termination position END can be specified using the undetected position UDP and a distance D defined according to the vehicle speed of the vehicle A.

More specifically, the image generation unit 102 has a data table in which a plurality of vehicle speeds of the vehicle A and the distances D associated with the respective vehicle speeds are registered. The image generation unit 102 acquires the speed information of the vehicle A from the volatile storage device 130, and refers to the data table to specify the distance D associated with the vehicle speed of the vehicle A indicated by the speed information. The image generation unit 102 can specify the termination position END by using the coordinate position of the undetected position UDP in the virtual three-dimensional space and the distance D. The position at the distance D from the undetected position UDP in the traveling direction of the vehicle A corresponds to the termination position END.

In S119, the display control unit 106 transmits the image generated by the image generation processing in S118 to the HUD device 13. Upon receiving the image, the HUD device 13 projects the image toward the windshield WS. As a result, as shown in FIG. 22, the image contents CT1, CT2, and CT5 are imaged in the image forming area IA. At the termination position END, the image content CT5 corresponding to the virtual object VO3 is displayed. The image content CT5 is a superimposition content and is displayed in association with the termination position END on the actual road surface. The image shown in FIG. 22 corresponds to the termination notification image for notifying the termination of the lane keeping control function.

The image generation unit 102 may synthesize the image generated by the image generation processing in step S118 and the image drawing the image content CT6 as shown in FIG. 23, and the display control unit 106 may transmit the synthesized image to the HUD device 13. Upon receiving the synthesized image, the HUD device 13 projects the synthesized image toward the windshield WS. As a result, the image contents CT1, CT2, and CT6 as shown in FIG. 23 are imaged in the image forming area IA. The image content CT6 is an image content that urges the driver to grasp the steering wheel. The image content CT6 is a non-superimposition content and is displayed at a predetermined position in the image forming area IA without being associated with any object in the foreground. The image shown in FIG. 23 corresponds to the termination notification image for notifying the lane keeping control function.

In the example shown in FIG. 23, the shape of the steering wheel is adopted as an example of the image content for urging the driver to hold the steering wheel. Alternatively, icons having various other shapes may be used so as to urge the driver to hold the steering wheel. Further, a comment urging the driver to hold the steering wheel may be displayed as an image content.

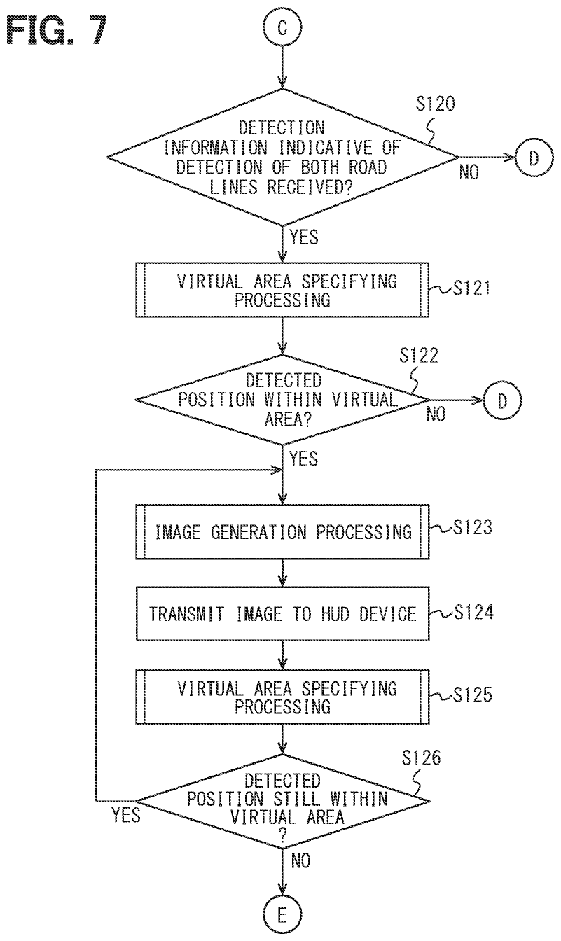

On the other hand, when it is determined in S117 that the measurement time is less than the threshold value (NO), the processing branches to S120 in FIG. 7. In S120, the receiving unit 101 determines whether or not the detection information indicating that the road lines on both sides of the traveling lane of the vehicle A are detected is received. When the detection information is not received (S120: NO), the processing returns to S115 in FIG. 6. On the other hand, when the detection information is received (S120: YES), the processing branches to S121.

In S121, the image generation unit 102 executes a virtual area specifying processing to specify the virtual area VA. In S122, the detection position determination unit 104 determines whether or not the detection position DP of the road line of the traveling lane of the vehicle A exists in the virtual area VA specified in S121. When the detection position DP does not exist in the virtual area VA (S122: NO), the process returns to S115 in FIG. 6. On the other hand, when the detection position DP exists in the virtual area VA (S122: YES), the processing branches to S123.

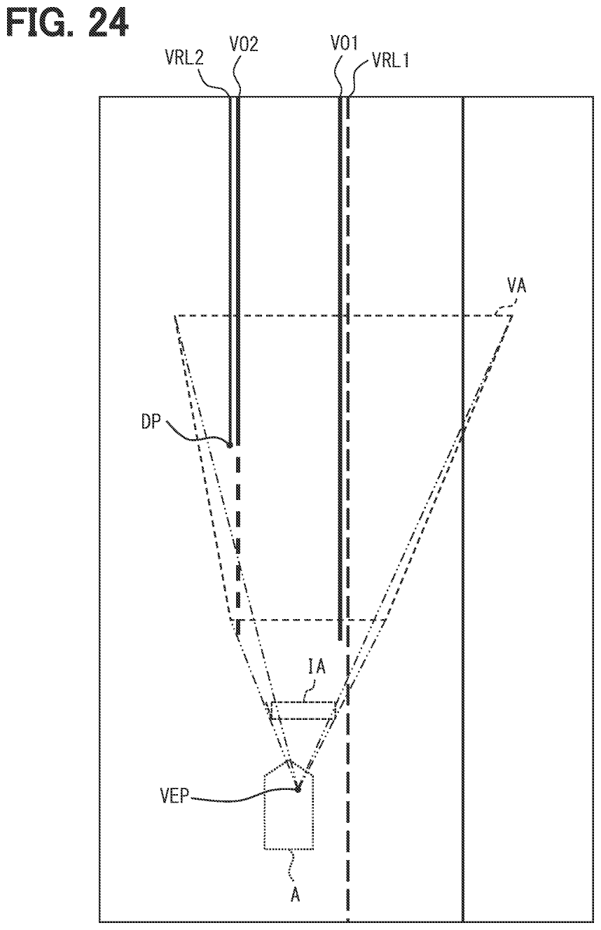

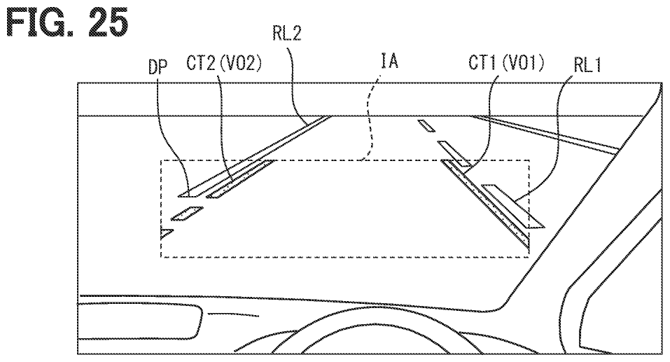

In S123, the image generation unit 102 executes an image generation processing to generate an image as shown in FIG. 25. In the image generation processing, as shown in FIG. 24, the image generation unit 102 draws the continuously detected virtual object VO1 of the road line with a solid line. Further, the image generation unit 102 can draw the virtual object VO2 of the detected road line, which is detected again, with a dotted line and a solid line. In this case, the image generation unit 102 may draw the virtual object VO2 on a near side (i.e., on a side close to the vehicle A) from the detection position DP with a dotted line and draw the virtual object VO2 on a far side (i.e., forward side) from the detection position DP with a solid line, with reference to the virtual viewpoint position VEP.

In S124, the display control unit 106 transmits the image generated by the image generation processing of S123 to the HUD device 13. Upon receiving the image, the HUD device 13 projects the image toward the windshield WS. As a result, the image contents CT1 and CT2 as shown in FIG. 25 are imaged in the image forming area IA.

In S125, the image generation unit 102 executes a virtual area specifying processing to specify the virtual area VA. In S126, the detection position determination unit 104 determines whether or not the detection position DP of the road line of the traveling lane of the vehicle A still exists in the virtual area VA specified in S125. When the detection position DP exists in the virtual area VA (S126: YES), the process returns to S123. On the other hand, when the detection position DP does not exist in the virtual area VA (S126: NO), the process returns to S104 shown in FIG. 4.

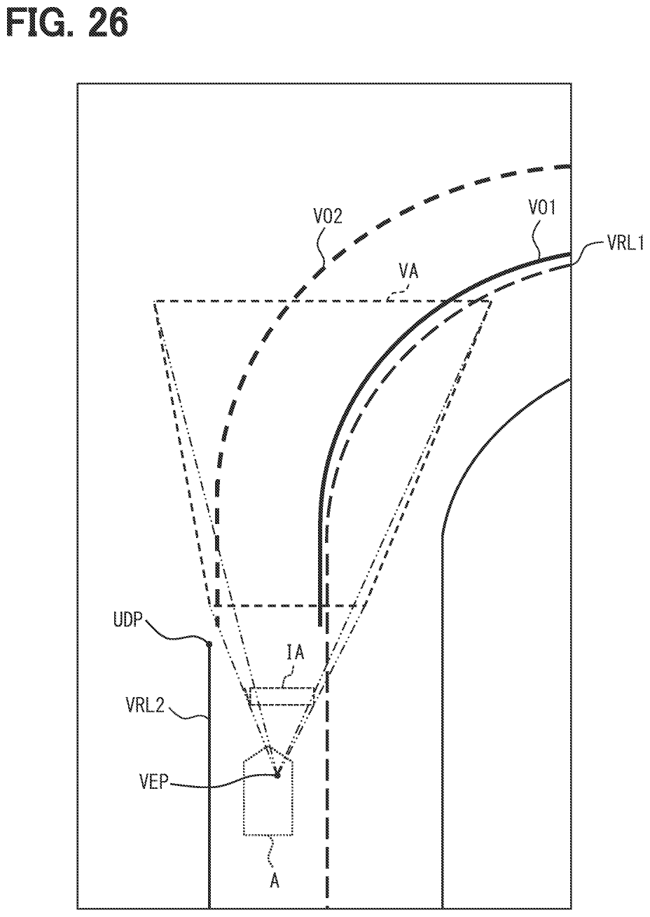

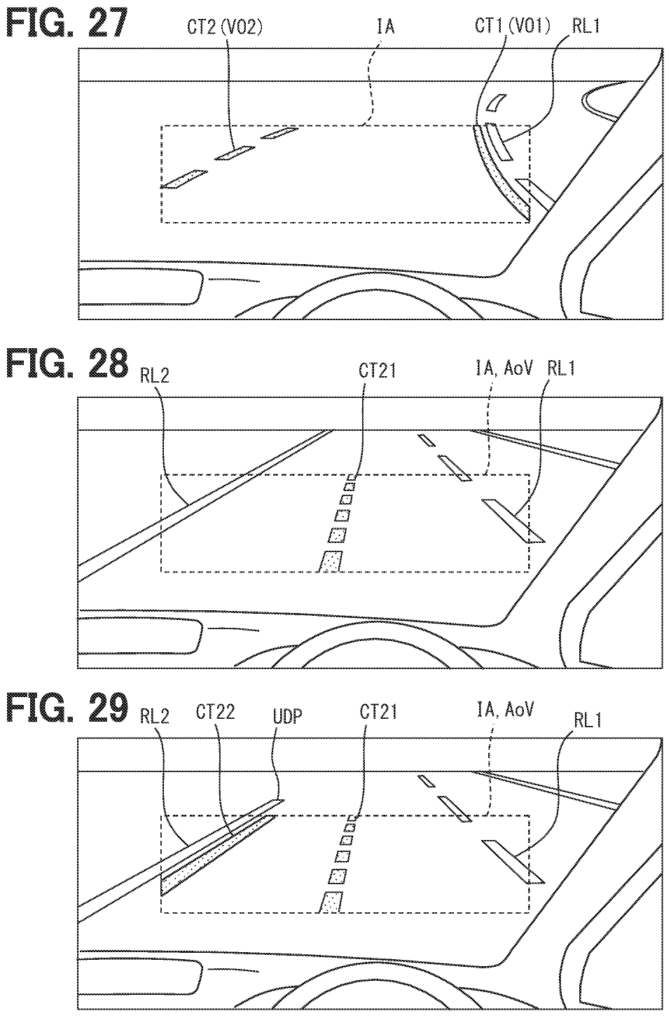

Next, with reference to FIGS. 26 and 27, a method of drawing a virtual object when the traveling lane in front of the vehicle A is curved will be described.

The driving assistance ECU 50 can analyze the captured image provided by the front camera 21 to calculate the radius of curvature of the traveling lane in front of the vehicle A. The driving assistance ECU 50 provides the display control device 100 with information indicating the radius of curvature of the traveling lane.

When the display control device 100 receives the information indicating the radius of curvature of the traveling lane, the image generation unit 102 changes the drawing position of the virtual objects VO1 and VO2 according to the magnitude of the radius of curvature of the traveling lane and draws the virtual objects VO1 and VO2 at the changed positions. Specifically, the image generation unit 102 draws the virtual objects VO1 and VO2 closer to the center of the traveling lane when the radius of curvature of the traveling lane is small, as compared with the case where the radius of curvature of the traveling lane is large.

FIG. 26 shows a virtual three-dimensional space when the traveling lane is curved. The example shown in FIG. 26 assumes a case where the road line is detected only on one side. The image generation unit 102 draws the virtual object VO1 on the center side of the traveling lane with reference to the virtual road line VRL1. In this case, in a situation where the radius of curvature of the traveling lane is small, the image generation unit 102 increases the amount of offset of the virtual object VO1 from the virtual road line VRL1 to be larger than that of when the radius of curvature of the traveling lane is large, so that the virtual object VO1 is drawn at a position closer to the center in the traveling lane. Further, the image generation unit 102 may reduce the amount of offset of the virtual object VO2 from the virtual road line VRL1 smaller than that when the radius of curvature of the traveling lane is large, so that the virtual object VO2 is drawn at a position closer to the center in the traveling lane.

When the HUD device 13 projects the image of the virtual three-dimensional space shown in FIG. 26 toward the windshield WS, the image contents CT1 and CT2 as shown in FIG. 27 are imaged in the image forming area IA. When the radius of curvature of the traveling lane is small, the image contents CT1 and CT2 are displayed at positions closer to the center of the traveling lane, as compared with the case where the radius of curvature of the traveling lane is large. The image shown in FIG. 27 corresponds to the termination notification image for notifying the termination of the lane keeping control function.

(Effects of First Embodiment)

In the first embodiment described above, in the case where the lane keeping control function for driving the vehicle A in the traveling lane ends, the image generation unit 102 generates the termination notification image for notifying the driver of the termination of the lane keeping control function. Then, the display control unit 106 provides the termination notification image to the HUD device 13, so that the HUD device 13 displays the termination notification image. As a result, when the lane keeping control function is terminated, the termination notification image is displayed in front of the driver. The driver can understand the termination of the lane keeping control function by visually recognizing the termination notification image displayed in front of the driver. As such, the convenience of the driver thus improves.

Further, when the lane keeping control function is terminated, the image generation unit 102 generates the image that includes the image content for the detected road line and the image content for the undetected road line (see FIG. 13 etc.). The image content for the detected road line is the image content displayed along the continuously detected road line among the road lines defining the traveling lane. The image content for the undetected road line is the image content displayed along the road line that is no longer detected. In this case, the image generation unit 102 generates the image so that the display mode of the image content for the detected road line and the display mode of the image content for the undetected road line are different.

Then, the display control unit 106 provides the image to the HUD device 13. Upon receiving the image, the HUD device 13 projects the image toward the windshield WS. As a result, when the lane keeping control function is terminated as the road line is detected only on one side of the traveling lane, the image content for the detected road line and the image content for the undetected road line are displayed in different display modes. Therefore, the driver can understand that the lane keeping control function is terminated by visually recognizing the image contents having different display modes. As such, the convenience of the driver improves.

When the lane keeping control function is being executed and is not terminated, the image generation unit 102 generates the image including the image contents for the detected road lines so that the display modes of the image contents for the detected road lines are constant. Then, the display control unit 106 provides the HUD device 13 with the image including the image contents for the detected road lines and causes the HUD device 13 to display the image.

As a result, when the lane keeping control function is not terminated, that is, when the road lines on both sides are being detected, only the image contents for the detected road lines are displayed in the same display mode. On the other hand, when the road line only on one side of the traveling lane is detected and the lane keeping control function is terminated, the image content for the detected road line and the image content for the undetected road line are displayed in different display modes. Therefore, the driver can understand that the lane keeping control function is terminated by visually recognizing the difference in the display mode of the image contents. As such, the convenience of the driver improves.

Further, the image generation unit 102 generates the image so that the image content for the undetected road line is displayed blinking and the image content for the detected road line is continuously displayed without blinking. Then, the display control unit 106 provides the image to the HUD device 13. Upon receiving the image, the HUD device 13 projects the image toward the windshield WS.

As a result, when the road line is detected only on one side of the traveling lane and the lane keeping control function is terminated, the image content for the undetected road line is displayed blinking and the image content for the detected road line is continuously displayed without blinking. Thus, the driver can visually recognize the blinking image content for the undetected road line, and understand the termination of the lane keeping control function, so the convenience of the driver improves.

The image generation unit 102 generates the image so that the image content for the undetected road line is displayed at a brightness lower than the brightness of the image content for the detected road line. Then, the display control unit 106 provides the image to the HUD device 13. Upon receiving the image, the HUD device 13 projects the image toward the windshield WS.

As a result, when the lane keeping control function is not terminated, that is, when the road lines on both sides are detected, only the image contents for the detected road lines with high brightness are displayed. On the other hand, when the road line is detected only on one side of the traveling lane and the lane keeping control function is terminated, the image content for the undetected road line with low brightness and the image content for the detected road line with high brightness are displayed. As a result, the driver can easily recognize the difference in the display mode of the image contents displayed on the windshield WS and understand the termination of the lane keeping control function. As such, the convenience of the driver improves.

The image generation unit 102 generates the image so that the image content for the detected road line is displayed on either the inside or the outside of the traveling lane. Then, the display control unit 106 provides the image to the HUD device 13. Upon receiving the image, the HUD device 13 projects the image toward the windshield WS. As a result, the image content for the detected road line is displayed on the inner side or the outer side of the road line.

In the case where the image content for the detected road line is displayed on the road line, that is, displayed at the same position as the road line, if the display position of the image content for the detected road line shifts, the image content for the detected road line is displayed at a different position from the road line. In this case, the driver can easily notice the deviation of the display position of the image content. As a result, the driver may feel uncomfortable with the image content.

However, in the present embodiment, the image content for the detected road line is displayed in the vicinity of the road line. As a result, even if the display position of the image content for the detected road line shifts, it is less likely that the driver will notice the shift in the display position of the image content. As such, the driver's discomfort can be suppressed.

Further, the image generation unit 102 generates the image including the image content CT4 indicating the remaining time until the lane keeping control function terminates. Then, the display control unit 106 provides the image to the HUD device 13. Upon receiving the image, the HUD device 13 projects the image toward the windshield WS (FIG. 19). As a result, the remaining time until the lane keeping control function terminates is displayed. As such, the driver can understand the remaining time to the termination of the lane keeping control function, and thus the convenience of the driver improves.

Further, the image generation unit 102 generates the image so that the image content CT5 indicating the end position of the lane keeping control function is displayed at the position on the traveling lane where the lane keeping control function is terminated. Then, the display control unit 106 provides the image to the HUD device 13. Upon receiving the image, the HUD device 13 projects the image toward the windshield WS (FIG. 22). As a result, on the windshield WS, the end position of the lane keeping control function is displayed in the traveling lane. In this way, the driver can understand the position where the lane keeping control function is terminated, so the convenience of the driver improves.

The image generation unit 102 generates the image including the image content CT6 that urges the driver to hold the steering wheel. Then, the display control unit 106 provides the image to the HUD device 13. Upon receiving the image, the HUD device 13 projects the image toward the windshield WS (FIG. 23). As a result, the image content CT6 that urges the driver to hold the steering wheel is displayed. In this way, the driver can easily understand the termination of the lane keeping control function, and thus the convenience of the driver improves.

The image generation unit 102 generates the image so that the image content CT3 indicating the undetected position UDP is displayed at the undetected position UDP of the road line that is no longer detected on the traveling lane. Then, the display control unit 106 provides the image to the HUD device 13. Upon receiving the image, the HUD device 13 projects the image toward the windshield WS (FIG. 16). As a result, the undetected position UDP is displayed in association with the road line that is no longer detected. In this way, the driver can recognize the existence of the undetected position UDP of the road line suggesting the termination of the lane keeping control function. Accordingly, the driver can easily understand the termination of the lane keeping control function, and thus the convenience of the driver improves.

The image generation unit 102 generates the image so that each of the image content for the detected road line and the image content for the undetected road line is displayed at a position based on the offset amount corresponding to each image content from the detected road line. Then, the display control unit 106 provides the image to the HUD device 13. Upon receiving the image, the HUD device 13 projects the image toward the windshield WS. Therefore, even when the road line of the traveling lane is detected only on one side, the image content for the detected road line and the image content for the undetected road line can be displayed.

In the situation where the traveling lane is curved, when the radius of curvature of the traveling lane is smaller, the image generation unit 102 draws the image content for the detected road line and the image content for the undetected road line more to the center of the traveling lane than that when the radius of curvature of the traveling lane is larger. Then, the display control unit 106 provides the image to the HUD device 13. Upon receiving the image, the HUD device 13 projects the image toward the windshield WS (FIG. 27). As a result, the smaller the radius of curvature of the traveling lane is, the more the image content for the detected road line is displayed closer to the center of the traveling lane.

When the traveling lane is curved, the smaller the radius of curvature of the traveling lane is, the easier the display position of the image content for the detected road line at a distant position shifts. In the present embodiment, the smaller the radius of curvature of the traveling lane is, the more the image content for the detected road lane is displayed on the center side of the traveling lane. Therefore, even if the display position of the image content for the detected road line shifts to the outside, it is less likely that the image content will be displayed on the road line. According to the above, the driver is less likely to notice the deviation of the display position of the image content, and the driver's discomfort can be suppressed.

### Second Embodiment

Hereinafter, a second embodiment of the present disclosure will be described with reference to FIGS. 1 to 7 and 28 to 43, focusing on the differences from the first embodiment.

In the second embodiment, the lane keeping control unit 52 continues the operation of the lane keeping control function to drive the vehicle A in the traveling lane, even when one of the road lines RL1 and RL2 on the left and right sides of the traveling lane is undetected during the execution state of the lane keeping control function. The lane keeping control unit 52 continues the lane keeping control along the road line RL2 (or RL1) on one side for a predetermined period longer than that of the first embodiment, and then transitions the lane keeping control function from the execution state to the standby state or to the OFF state.

In the second embodiment, in S102 shown in FIG. 4, the image generation unit 102 executes an image generation processing to generate an image as shown in FIG. 28. In S103, the display control unit 106 transmits the image generated by the image generation processing of S102 to the HUD device 13. Upon receiving the image, the HUD device 13 projects the image toward the windshield WS. As a result, the image content CT21 as shown in FIG. 28 is imaged in the image forming area IA.

The image content CT21 is an LTA content indicating the execution state of the lane keeping control function, and is an image content for a detected road line displayed when the road lines RL1 and RL2 on both the left and right sides defining the driving lane are detected. The image content CT21 is a superimposition content superimposed at the center of the traveling lane, in other words, on a road surface position approximately equidistant from the road lines RL1 and RL2 on both the left and right sides. The image content CT 21 is drawn in a dotted line shape (broken line shape) extending along the extending direction of the traveling lane. Due to such a drawing shape, it is less likely that the driver will recognize the deviation of the superimposition content with respect to the road. The image content CT 21 repeats a display state and a hidden state at a predetermined cycle by means of blinking display. As an example, the image content CT 21 continues the displayed state for 5 seconds, then continues the hidden state for 5 seconds, and then returns to the displayed state again. The period of the hidden state may be shorter or longer than the period of the displayed state.

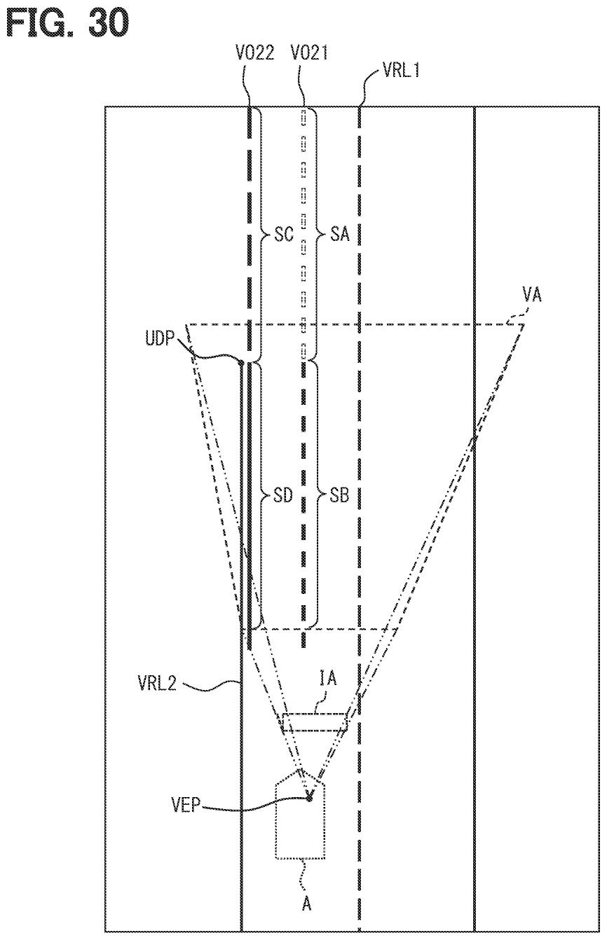

In S108, the undetected position determination unit 103 determines whether or not the undetected position UDP of the road line of the traveling lane of the vehicle A as shown in FIG. 30 exists in the virtual area VA specified in S107. When the undetected position UDP does not exist in the virtual area VA (S108: NO), the processing branches to S109.

In S109, the image generation unit 102 executes an image generation processing to generate an image as shown in FIG. 29. In S110, the display control unit 106 transmits the image generated by the image generation processing of S109 to the HUD device 13. Upon receiving the image, the HUD device 13 projects the image toward the windshield WS. As a result, the image contents CT21 and CT22 as shown in FIG. 29 are imaged in the image forming area IA. The image shown in FIG. 29 corresponds to a continuation notification image for notifying the driver of the continuation of the operation of the lane keeping control function.

As described above, when the undetected position UDP is outside the angle of view AoV, the image generation unit 102 generates the continuation notification image so that the blinking of the image content CT21 superimposed on the center of the road surface is interrupted, and the image content CT21 is continuously displayed without blinking. As a result, the image content CT 21 is fixed in the displayed state.

Further, the image generation unit 102 generates a continuation notification image including an image content CT22 that highlights the road line RL2 that is no longer detected together with the image content CT21. The image content CT 22 is drawn in a different display mode from the image content CT 21. Specifically, the image content CT21 is generated in a dotted line, whereas the image content CT22 is generated in a solid line. The image content CT 22 is superimposed at a position on the inner side of one road line RL2 that is detected as being interrupted in the traveling direction, and extends in a strip shape along the road line RL2. Similar to the image content CT21, the image generation unit 102 keeps the displayed state of the image content CT22 without blinking the image content CT22.

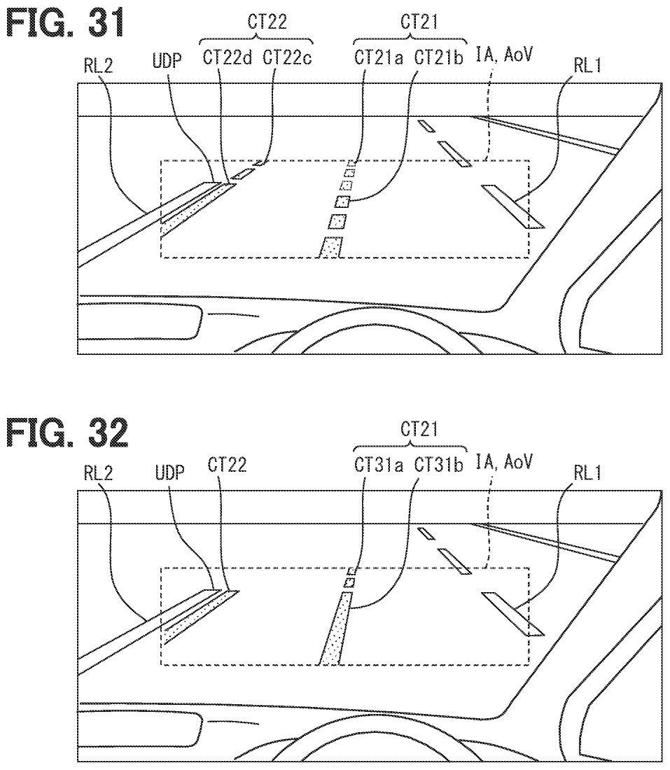

On the other hand, when it is determined in S108 that the undetected position UDP exists in the virtual area VA (YES), in S111, the image generation unit 102 executes an image generation processing to generate an image as shown in FIG. 31. In the image generation processing, the image generation unit 102 draws a virtual object VO21 with a dotted line at the center of the road surface of the subject vehicle lane, as shown in FIG. 30. Of the virtual object VO21, a part SB on a near side (on a side close to the subject vehicle A) from the undetected position UDP is drawn at a position substantially equidistant from the virtual road lines VRL1 and VRL2, with reference to the virtual road lines VRL1 and VRL2 (road lines RL1 and RL2) on both the left and right sides. On the other hand, of the virtual object VO21, a part SA on a far side (on the forward Ze) from the undetected position UDP is drawn at a position offset from the virtual road line VRL1 toward the center, with reference to one virtual road line VRL1 (road line RL1) corresponding to the road line RL1 continuously detected. The offset amount of the virtual object VO21 on the far side of the undetected position UDP is set to be substantially the same as the distance from the virtual road line VRL1 on the near side of the undetected position UDP.

Further, the image generation unit 102 draws the virtual object VO22 in a solid line or a dotted line in the vicinity of the inner side of the virtual road line VRL2 corresponding to the road line RL2 that is no longer detected. Of the virtual object VO22, a part SD on the near side from the undetected position UDP is drawn in a solid line at a position slightly offset toward the center side from the virtual road line VRL2, with reference to the virtual road line VRL2 (road line RL2) which is interrupted. On the other hand, of the virtual object VO21, a part SC on the far side from the undetected position UDP is drawn in a dotted line and at a position offset larger than the virtual object VO21 with respect to the virtual road line VRL1 (road line RL1) which is continuously detected. The offset amount of the virtual object VO21 at this time is determined based on the standard distance in the virtual three-dimensional space as in the first embodiment, and is adjusted so that there is no lateral deviation before and after the undetected position UDP.

Even if the undetected position UDP moves from the outside of the angle of view AoV to the inside of the angle of view AoV, as shown in FIG. 31, the display of the continuous notification image including the image content CT21 and the image content CT22 is continued, by the above virtual objects VO21 and VO22.

The image content CT21 includes a continuous display part CT21b indicating a section in which road lines RL1 and RL2 on both the left and right sides are detected, and a blinking display part CT21a indicating a section in which the road line is detected on only one side. The continuous display part CT21b corresponds to the image content for the detected road line. The continuous display part CT21b has a shape based on the part SB of the virtual object VO21 (see FIG. 30), and is continuously displayed without blinking. On the other hand, the blinking display part CT21a corresponds to the image content for the undetected road line. The blinking display part CT21a has a shape based on the part SA of the virtual object VO21 (see FIG. 30), and is displayed to blink at a predetermined cycle. The blinking cycle of the blinking display part CT21a is set shorter than the blinking cycle of the image content CT21 (see FIG. 28) when the lane keeping control is normally performed.

The image content CT22 includes a solid line display part CT22d indicating a section in which the road lines RL1 and RL2 on both the left and right sides are detected, and a dotted line display part CT22c indicating a section in which the road line RL1 is detected only on one side. The solid line display part CT22d has a shape based on the part SD of the virtual object VO22 (see FIG. 30), and is continuously displayed without blinking. The dotted line display part CT22c has a shape based on the part SC of the virtual object VO22 (see FIG. 30), and is continuously displayed without blinking.

In the image generation processing of step S111, the image generation unit 102 may draw a virtual object different from the one described above, and generate a continuous notification image including the image contents CT21 and CT22 as shown in FIG. 32. The image content CT21 includes a solid line display part CT31b and a dotted line display part CT31a. The solid line display part CT31b corresponds to the image content for the detected road line and is displayed in a solid line shape. On the other hand, the dotted line display part CT31a corresponds to the image content for the undetected road line and is displayed in a dotted line shape. The solid line display part CT31b and the dotted line display part CT31a are continuously displayed without blinking. The image content CT22 is displayed in a solid line shape on an inner side of the road line RL2 which is the one interrupted, in the section where the road lines RL1 and RL2 on both the left and right sides are detected. The image content CT22 is not superimposed and displayed in the section where only one road line RL1 is detected.

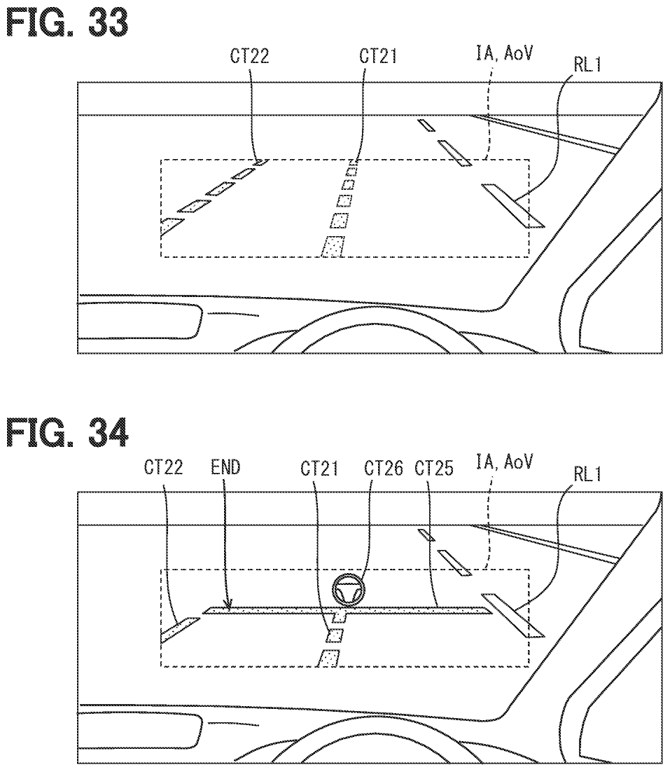

When it is determined in S114 that the undetected position UDP does not exist in the virtual area VA (NO), the image generation unit 102 executes an image generation processing in S115 to generate an image as shown in FIG. 33. In S116, the display control unit 106 transmits the image generated by the image generation processing of S115 to the HUD device 13. As a result, the HUD device 13 forms the image contents CT21 and CT22 as shown in FIG. 33 in the image forming area IA.

The image content CT21 is displayed in a dotted line shape similar to the blinking display part CT21a (see FIG. 31), and blinks at a predetermined cycle. On the other hand, the image content CT22 is drawn in a dotted line shape similar to the dotted line display part CT22c (see FIG. 31). The image content CT 22 may be displayed in a blinking manner, or may be continuously displayed without blinking. When the image content CT 22 is displayed to blink, the image generation unit 102 links the blinking of the image content CT 22 with the blinking of the image content CT 21. That is, the image generation unit 102 synchronizes the blinking of the image contents CT21 and CT22 so that the image contents CT21 and CT22 are displayed and hidden at the same timing. The blinking cycle in this case is also set shorter than the blinking cycle when the lane keeping control is normally performed. When the continuation notification image shown in FIG. 32 is displayed, the image content CT 21 may continue to be displayed without blinking, as the dotted line display part CT31a. Further, the image content CT 22 may not be displayed.

When it is determined in S117 that the measurement time is equal to or longer than the threshold value (YES), in S118 the image generation unit 102 executes an image generation processing to generate an image as shown in FIG. 34. In S119, the display control unit 106 transmits the image generated by the image generation processing of S118 to the HUD device 13. As a result, the HUD device 13 forms images of the image contents CT21, CT22, CT25, and CT26 in the image forming area IA, as shown in FIG. 34. The image shown in FIG. 34 corresponds to the termination notification image for notifying the termination of the lane keeping control.

The image content CT21 and the image content CT22 are displayed in a dotted line shape in the center of the road surface on the near side from the end position END that is set at a position at a specific distance from the undetected position UDP. The image content CT21 continues to be displayed without blinking. On the other hand, the image content CT 22 may be either a blinking display or a non-blinking display. Further, the image content CT 22 may not be displayed. The image content CT25 is displayed as a superimposition content, and is displayed in association with the end position END on the actual road surface. The image content CT25 has a shape extending in the width direction of the traveling lane and is superimposed on the end position END. The image content CT26 is a non-superimposition content and is displayed above the center of the image forming area IA (angle of view AoV). The image content CT26 is visually recognized on a far side of the image content CT25. The image content CT26 has an icon shape that imitates the shape of the steering wheel, and urges the driver to grasp the steering wheel.

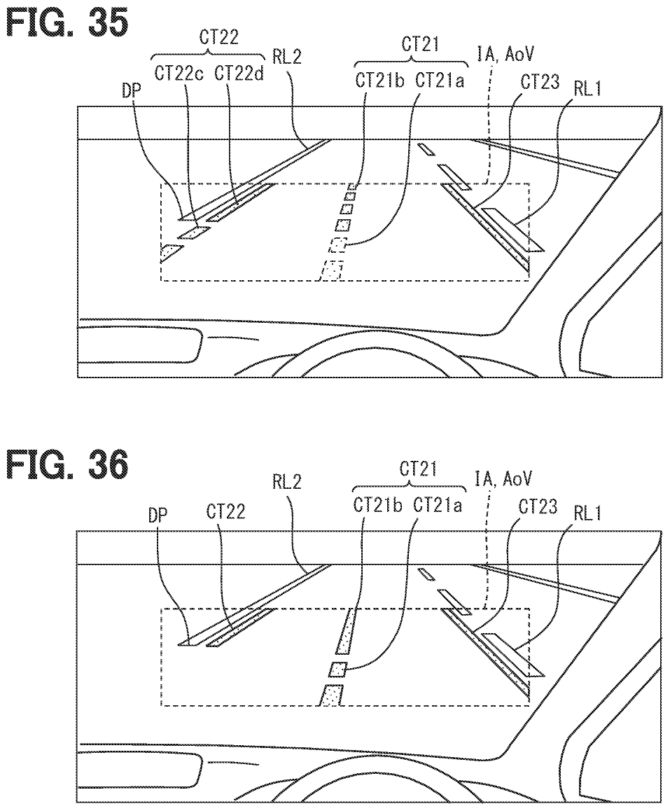

When it is determined in S122 that the detection position DP of the road line exists in the virtual area VA (YES), the image generation unit 102 executes the image generation processing in S123 to generate an image as shown in FIG. 35. In S124, the display control unit 106 transmits the image generated by the image generation processing of S123 to the HUD device 13. As a result, the HUD device 13 forms the images of the image contents CT21, CT22, and CT23 as shown in FIG. 35 in the image forming area IA. The image shown in FIG. 35 corresponds to the continuation notification image for notifying the continuation of the lane keeping control.

The image content CT21 includes the blinking display part CT21a and the continuous display part CT21b, which are drawn in a dotted line shape, similarly to the continuous notification image (see FIG. 31) for notifying the interruption of the road line RL2. The blinking display part CT21a indicates a section in which the road line is detected only on one side, and corresponds to the image content for the undetected road line. The blinking display part CT21a is superimposed on the near side from the continuous display part CT21b and is displayed to blink. The continuous display part CT21b indicates a section where the road lines RL1 and RL2 on both the left and right sides are detected, and corresponds to the image content for the detected road line. The continuous display part CT21b continues to display without blinking. After the detection position DP moves out of the angle of view AoV, the continuous display part CT21b (image content CT21) repeats the displayed state and the hidden state at a predetermined cycle.

The image content CT22 includes the dotted line display part CT22c and the solid line display part CT22d, as in the continuous notification image (see FIG. 31) for notifying the interruption of the road line RL2. The dotted line display part CT22c and the solid line display part CT22d continue to display without blinking. The dotted line display part CT22c indicates a section in which the road line RL1 is detected only on one side. The solid line display part CT22d indicates a section in which the road lines RL1 and RL2 on both the left and right sides are detected. The image content CT22 is an image content that highlights the road line RL2 for which detection has been resumed.

The image content CT23 is generated in a solid line shape similar to the solid line display part CT22d. The image content CT23 is superimposed on the inner side of the road line RL1 that is continuously detected, and extends in a stripe shape along the road line RL1. The image content CT23 continues to display without blinking. The image content CT23 is displayed in substantially the same manner as the solid line display part CT22d. The image content CT23, in collaboration with the solid line display part CT22d (image content CT22), notifies the driver that the state has changed from the state of detecting the road line only on one side to the state of detecting the road lines RL1 and RL2 on both the left and right sides. The image content CT23 and the solid line display part CT22d are terminated when a predetermined time elapses after the image content CT21 (continuous display part CT21b) starts blinking.

In the case where the continuous notification image shown in FIG. 32 have been displayed in the S111, the image generation unit 102 may generate the image contents CT21, CT22, CT23 as shown in FIG. 36 in the image generation processing of S123.

The image content CT21 includes the dotted line display part CT31a displayed in a dotted line shape and the solid line display part CT31b displayed in a solid line shape, similarly to the continuous notification image (see FIG. 32) for notifying the interruption of the road line RL2. The dotted line display part CT31a is displayed on the near side corresponds to the image content for the undetected road line. The solid line display part CT31b displayed on the far side corresponds to the image content for the detected road line.

The image content CT22 is superimposed and displayed in a solid line shape on the inner side of the road line RL2 which is detected again and on the far side of the detection position DP in the section where the road lines RL1 and RL2 on both the left and right sides are detected. The image content CT 22 is image content that highlights the road line the detection of which has been resumed. The image content CT23 is superimposed and displayed in a solid line shape on the inner side of the road line RL1 which is continuously detected.

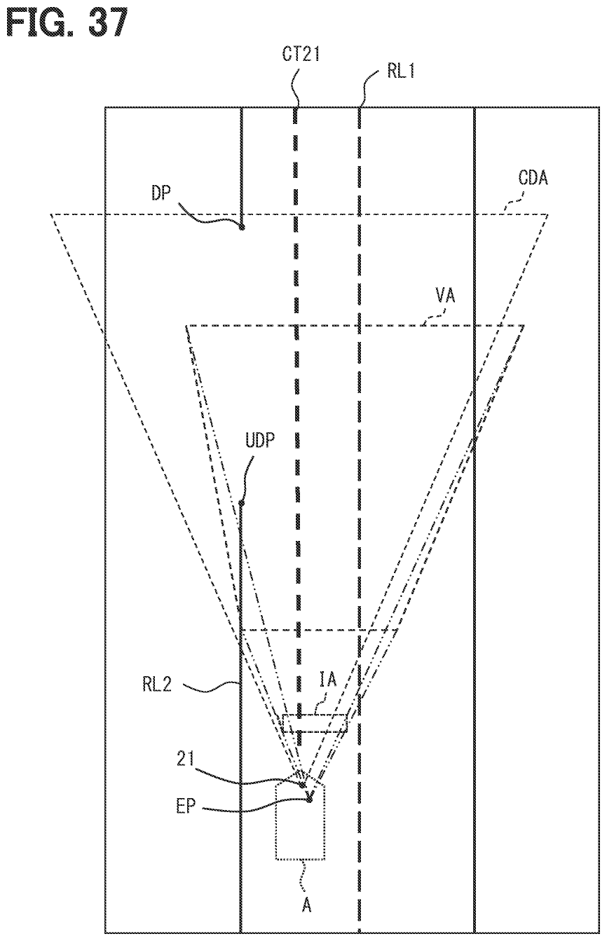

Next, with reference to FIGS. 37 to 39, a continuation notification image in a scene where the road line on one side is temporarily interrupted will be described. In such a scene, the lane keeping control unit 52 changes from the state where the road lines RL1 and RL2 on both sides are detected to the state where only the road line RL1 on one side is detected, and the state where the road lines RL1 and RL2 on both sides are detected again. In this way, even if the road line RL2 on one side is temporarily undetected, the lane keeping control unit 52 can continue the lane keeping control. At this time, the image generation unit 102 notifies the continuation of the operation of the lane keeping control while suppressing the change of the image content so that the displayed state and the hidden state of the image content are not repeated.

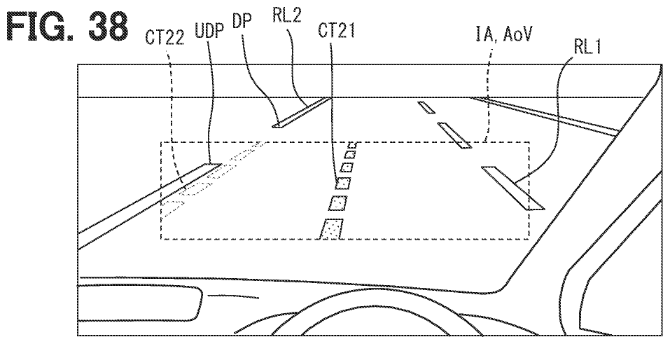

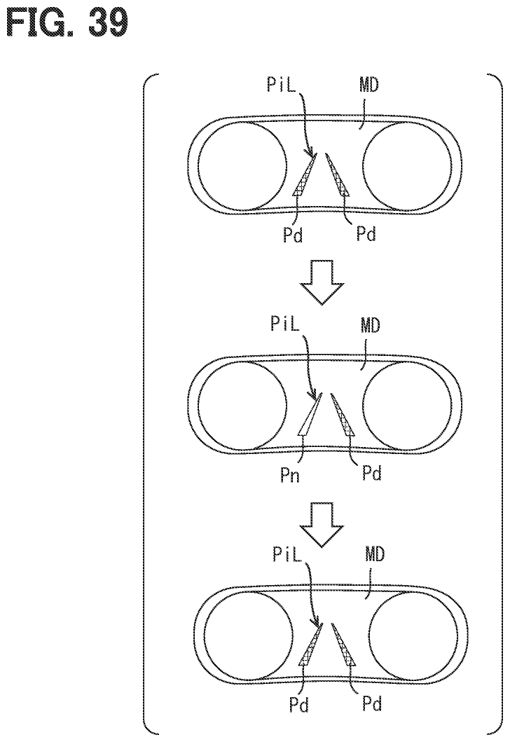

When the lane keeping control unit 52 detects the detected position DP in addition to the undetected position UDP from the image captured by the front camera 21 (see the detection range CDA in FIG. 37), the lane keeping control unit 52 provides the display control device 100 with detection information indicating that the state where the road line is detected only on one side is temporary. In this case, as shown in FIG. 38, the image generation unit 102 does not display the image content CT22 that emphasizes the road line RL2 on the interruption side. When the image content CT22 has been displayed, the image generation unit 102 hides the image content CT22.

In addition, the image generation unit 102 displays the image content CT21 similar to the case where the lane keeping control is performed based on the road lines RL1 and RL2 on both sides. The image content CT 21 repeats the displayed state and the hidden state at a predetermined cycle. Further, the image generation unit 102 may continue to display the image content CT21, until the detection position DP moves out of the angle of view AoV, without hiding the image content CT21 once displayed.

Further, as shown in FIG. 39, the display control device 100 causes the meter display DM to display an LTA status PiL indicating whether or not the road lines RL1 and RL2 on the left and right sides are detected. The display control device 100 notifies the driver in real time of the detection status of the road lines RL1 and RL2 by the LTA status PiL. Therefore, the virtual image display by the HUD device 13 and the image display by the meter display DM have different contents.

Specifically, in a scene where the road line RL2 on the left side is temporarily interrupted (see FIG. 37), the LTA status PiL including a pair of linear detected images Pd is displayed on the meter display DM while the road lines RL1 and RL2 on both sides are detected, as shown in FIG. 39. Then, for example, when the road line RL2 on the left side is no longer detected, a left one of the pair of detected images Pd is changed to an undetected image Pn having a mode different from that of the detected image Pd, such as a while blanked image or the like. Further, when the road line RL2 on the left side is detected again, the undetected image Pn on the left side is changed to the detected image Pd. As described above, the LTA status PiL can notify the driver in real time of accurate information indicating whether or not the road lines RL1 and RL2 on the left and right sides are detected, based on the detection information provided by the lane keeping control unit 52.

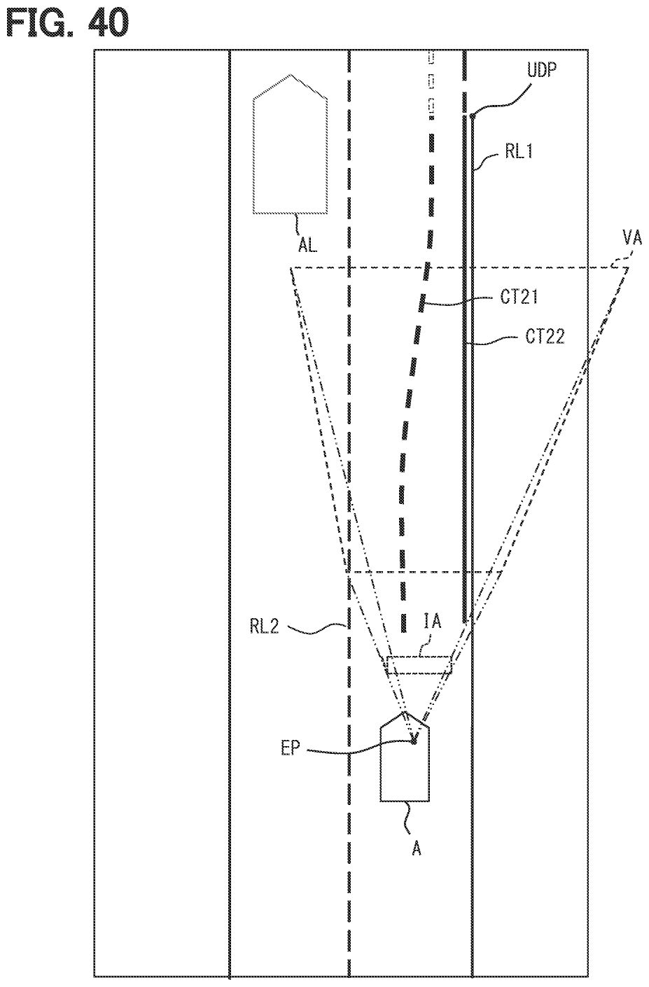

Next, with reference to FIGS. 40 to 43, an image in a scene where the road line RL1 on one side is interrupted during the execution of an offset control will be described.

The lane keeping control unit 52 can execute the offset control as one function of the lane keeping control. The offset control is a control that offsets the traveling position of the vehicle A in the traveling lane from the reference position (for example, the central portion of the lane) in either the left or right direction so as to move away from a specific control target. As an example, as shown in FIG. 40, when overtaking a large vehicle AL traveling in an adjacent lane as a specific control target, the lane keeping control unit 52 offsets the traveling position of the subject vehicle in the traveling lane in a direction away from the large vehicle AL. The lane keeping control unit 52 provides the display control device 100 with control information related to the offset control.

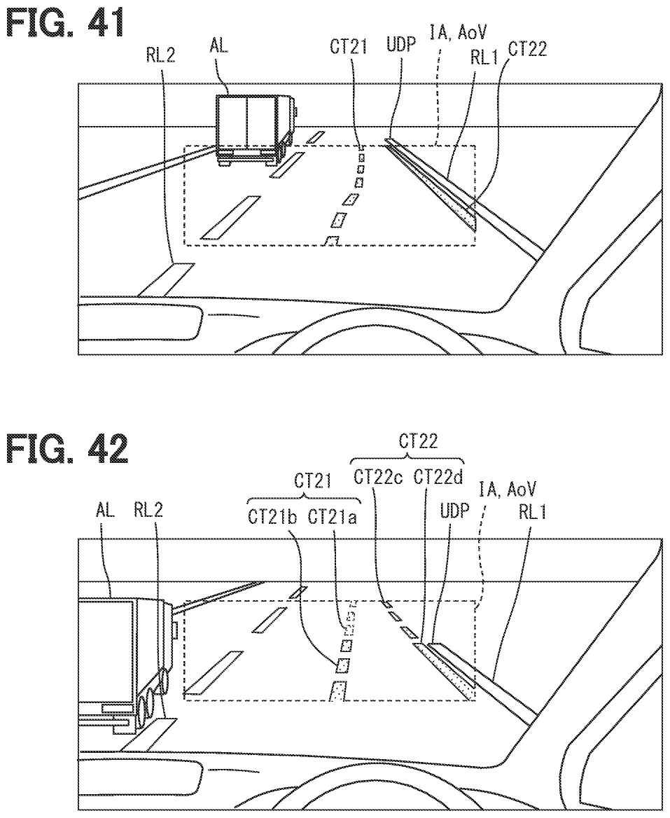

Based on the control information of such offset control, the image generation unit 102 generates an image including the image content CT 21 that curves in a direction away from the large vehicle AL, as shown in FIG. 41. The image content CT21 shows the scheduled traveling route of the subject vehicle and notifies the driver of the lateral movement of the subject vehicle due to the offset control.

The lane keeping control unit 52 can continue traveling in the lane with the offset control even if the road line RL1 on one side is interrupted during the offset control. In this case, the image generation unit 102 generates a continuation notification image for notifying the continuation of the operation of the lane keeping control, as shown in FIGS. 41 and 42.

Specifically, when the undetected position UDP of the road line RL1 is outside of the angle of view AoV, the image generation unit 102 generates the continuation notification image including the image content CT22 together with the image content CT21, similarly to the case where the offset control is not executed (see FIG. 29). As shown in FIGS. 40 and 41, the image content CT 22 is a highlight content that is superimposed and displayed on the road surface on an inner side of the interrupted road line RL1 to highlight the road line RL1.

When the undetected position UDP moves into the angle of view AoV, the image generation unit 102 generates a continuous notification image including the image contents CT21 and CT22, similar to the case where the offset control is not executed (see FIG. 31). As shown in FIG. 42, the image content CT21 has a continuous display part CT21b and a continuous blinking display part CT21a continuous from the continuous display part CT21b on the far side. The continuous display part CT21b and the blinking display part CT21a have different display modes from each other. Further, the image content CT22 has a solid line display part CT22d and a dotted line display part CT22c that is continuous on the far side of the solid line display part CT22d. The solid line display part CT22d and the dotted line display part CT22c have different display modes from each other.

Further, the continuous display part CT21b and the solid line display part CT22d are superimposed and displayed on the road surface on the near side from the undetected position UDP, to indicate the section where the road lines RL1 and RL2 on both the left and right sides are detected. On the other hand, the blinking display part CT21a and the dotted line display part CT22c are superimposed and displayed on the road surface on the far side of the undetected position UDP to indicate the section in which only the road line RL2 on one side is detected. As shown in FIG. 32, the image generation unit 102 may generate a continuous notification image including the image content CT21 that has a solid line display part CT31b and a dotted line display part CT31a and the image content CT22 exhibiting a solid line shape.

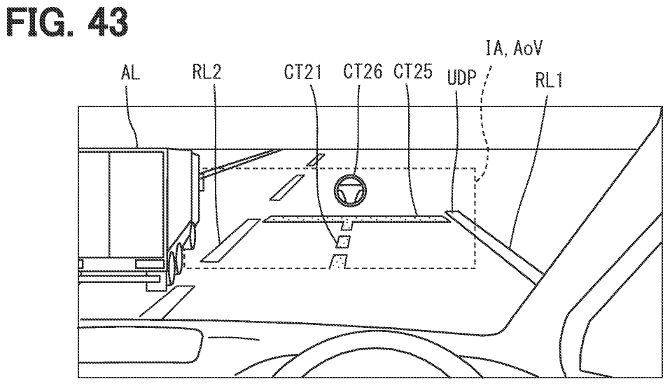

Further, the lane keeping control unit 52 may shift the operating state of the lane keeping control to the OFF state or the standby state when the road line RL1 on one side is interrupted during the offset control. In this case, as shown in FIG. 43, the image generation unit 102 generates the termination notification image including the image contents CT21, CT25, and CT26. The image contents CT21, CT25, and CT26 are substantially the same image contents as when the offset control is not executed (see FIG. 34).

Specifically, the image content CT 21 is superimposed and displayed on the road surface on the near side from the end position END (undetected position UDP) on the road surface. The image content CT25 has a shape extending in the width direction of the traveling lane and is superimposed and displayed on the end position END. The image content CT 26 is displayed above the image content CT 25 when viewed from the driver. As a result, the image content CT26 is visually recognized by the driver so as to be superimposed on the road surface on the forward side, that is, on the far side of the undetected position UDP. The image content CT26 is a non-superimposition content that urges the driver to operate the steering wheel.

(Effects of Second Embodiment)

In the second embodiment described above, when the lane keeping control function for driving the vehicle A in the traveling lane continues to operate even if one of the road lines RL1 and RL2 on the left and right sides is not detected, the image generation unit 102 generates the continuation notification image that notifies the driver of the continuation of the lane keeping control function. Then, the display control unit 106 provides the continuation notification image to the HUD device 13, and causes the HUD device 13 to display the continuation notification image. As a result, even if one of the road lines RL1 and RL2 disappears, the driver can understand the continuation of the lane keeping control function by visually recognizing the continuation notification image. In this way, by notifying the driver in advance of the operating state of the lane keeping control function, it is possible to improve the convenience of the driver.

Further, the continuous notification image generated by the image generation unit 102 includes at least one of the image content for the detected road line and the image content for the undetected road line. Examples of the image content for the detected road lines are the image contents CT21 of FIG. 28, the continuous display part CT21b of FIGS. 31 and 35, and the like, and the image content for the detected road line indicates the section where the road lines RL1 and RL2 on both the left and right sides are detected. Further, examples of the image content for the undetected road line are the blinking display part CT21a in FIGS. 31 and 35, the image content CT21 in FIG. 33, and the like, and the image content for the undetected road line indicates the section where only one of the road lines RL1 and RL2 is detected.

According to the above, the continuation notification image can notify the driver whether the lane keeping control is performed in the situation where the road lines RL1 and RL2 on both sides are detected, or whether the lane keeping control is performed in the situation where the road line on only one side is detected. As a result, the convenience of the driver is improved.

Further, the image generation unit 102 generates the continuation notification image including the image content CT22 that emphasizes the road line that is no longer detected together with the image content for the detected road line (for example, the continuous display part CT21b or the like, see FIG. 31). Based on the above, the continuation notification image can present the interruption of the road line RL2 to the driver in an easy-to-understand manner before shifting to the lane keeping control based on the road line RL1 on one side.

In addition, the image generation unit 102 generates the continuation notification image that includes the image content CT22 highlighting the road line which has been detected again together with the image content for the detected road line (for example, the blinking display part CT21a and the like, see FIG. 35). Based on the above, the continuation notification image can clearly present to the driver the resumption of detection of the road line RL2 before shifting to the lane keeping control based on the road lines RL1 and RL2 on both sides.

Further, when the interruption of the road line is temporary, the image generation unit 102 stops the display of the image content CT 22 and suppresses to change the display of the continuous notification image. Therefore, it is possible to avoid a situation in which the continuous notification image becomes difficult to see due to repeated changes in display modes. Further, the LTA status PiL displayed on the meter display DM provides accurate information indicating the detection and non-detection (undetected) of the road lines RL1 and RL2 in real time. As a result, the convenience of the driver is further improved.

Further, even if the road line is not detected during the execution of the offset control by the lane keeping control unit 52, the image generation unit 102 generates the continuation notification image or the termination notification image, thereby to notify the driver of a control schedule of the lane keeping control unit 52. As a result, the effect of improving the convenience of the driver will be exhibited in more scenes.

Specifically, in the scene where the offset control is executed by the lane keeping control function, even if the road line on one side is undetected, the image generation unit 102 generates the image content for the undetected road line in the display mode different from the image content for the detected road line. Therefore, the driver can understand the change in the detection state of the road line by visually recognizing the continuation notification image.

Further, when the offset control is performed by the lane keeping control function, the image generation unit 102 generates the termination notification image including the image content CT26 for urging the driver to hold the steering wheel even when one of the road lines is not detected. As a result, the driver can easily recognize the termination of the lane keeping control function, and the convenience of the driver improves.

### Other Embodiments

The present disclosure is not limited to the above-described embodiments, and may be modified in various ways. For example, the display control device 100 may generate an image including an image content indicating the remaining distance until the lane keeping control function ends, and causes the HUD device 13 to project the image. In this case, the display control device 100 calculates the distance between the lane keeping function end position END and the virtual viewpoint position VEP in the virtual three-dimensional space, and converts the calculated distance into the actual distance so as to obtain the remaining distance until the lane keeping control function ends. In this way, the remaining distance is obtained and displayed. As a result, the driver can recognize the remaining distance until the end of the lane keeping control function, and the convenience of the driver improves.

As another embodiment, the display control device 100 may generate an image including an image content indicating the remaining time and remaining distance until the lane keeping control function ends, and causes the HUD device 13 to project the image generated. As a result, the remaining time and the remaining distance until the lane keeping control function ends are displayed. As a result, the driver can recognize the remaining time and the remaining distance until the end of the lane keeping control function, and the convenience of the driver improves.

In further another embodiment, when drawing a virtual object of an undetected road line, the image generation unit 102 may use the high-precision map information of the undetected road line to generate the virtual object of the road line. In this case, the image generation unit 102 can request the locator ECU 34 for the high-precision map information of the road line, and can acquire the high-precision map information of the road line registered in the map DB 33. Since the high-precision map information includes the position information of the road line that is detected, the image generation unit 102 can draw a virtual object of the road line based on the position information of the road line.

In yet another embodiment, the display control device 100 can generate an image including an image content indicating at least one of the remaining time and the remaining distance until the lane keeping control function ends, without generating the image including the image contents CT1 and CT2 highlighting the road lines.

In still another embodiment, the display control device 100 may generate an image including only an image content indicating the end position of the lane keeping control function without generating the image including the image contents CT1 and CT2 highlighting the road lines, and cause the HUD device 13 to project the image.

In still another embodiment, the display control device 100 may generate an image including only an image content for urging the driver to hold the steering wheel without generating an image including the image contents CT1 and CT2 for highlighting the road lines, and cause the HUD device 13 to project the image.

In still another embodiment, the display control device 100 may generate an image including only an LTA content in the center of a traveling lane, without generating an image including an image content for highlighting the undetected road line or the road line detected again, and cause the HUD device 13 to project the image.

In still another embodiment, the display control device 100 can generate the continuation notification image so that the image content for the undetected road line is displayed with a brightness lower than the brightness of the image content for the detected road line. Further, the display control device 100 can generate the continuation notification image so that the image contents for the detected road lines such as the image contents CT22 and CT23 are displayed on the outside of the traveling lane.

In still another embodiment, the display control device 100 can adjust the drawing position of the image content included in the continuation notification image according to the radius of curvature of the curve of the traveling lane. Specifically, in a case where the traveling lane is curved, the display control device 100 can draw the image content for the detected road line and the image content for the undetected road line at positions closer to the center of the traveling lane when the radius of curvature of the traveling lane is small, than the positions when the radius of curvature of the traveling lane is large.

The control units and methods described in the present disclosure may be implemented by one or more special-purposed computers. Such a special-purposed computer may be provided (i) by configuring (a) a processor and a memory programmed to execute one or more functions embodied by a computer program, or (ii) by configuring (b) a processor including one or more dedicated hardware logic circuits, or (iii) by configuring by a combination of (a) a processor and a memory programmed to execute one or more functions embodied by a computer program and (b) a processor including one or more dedicated hardware logic circuits. The hardware logic circuit is a circuit having, for example, FPGA (Field Programmable Gate Array) and ASIC (Application Specific Integrated Circuits). Further, the computer program may be stored in a computer-readable non-transitory tangible storage medium as instructions to be executed by a computer. The technique for realizing the functions of each unit included in the condition estimation device does not necessarily need to include software, and all the functions may be realized using one or a plurality of hardware circuits.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A display control device for a head-up display of a vehicle, the display control device comprising:
an image generation unit configured to generate an image to be displayed by the head-up display; and
a display control unit configured to provide the image generated by the image generation unit to the head-up display, and cause the head-up display to display the image, wherein
the image generation unit is configured to generate a termination notification image for notifying a driver of the vehicle a termination of a lane keeping control function that drives the vehicle to travel in a traveling lane, in response to the lane keeping control function being terminated, and
the display control unit is configured to provide the termination notification image to the head-up display and cause the head-up display to display the termination notification image.

2. The display control device according to claim 1, wherein
in response to the lane keeping control function being terminated, the image generation unit is configured to generate, as the termination notification image, an image including (i) an image content for a detected road line to be displayed along a road line of the traveling lane that is continuously detected and (ii) an image content for an undetected road line to be displayed along a road line of the traveling lane that is no longer detected, and
the image content for the detected road line and the image content for the undetected road line have different display modes.

3. The display control device according to claim 2, wherein
in response to the lane keeping control function being executed and continued, the image generation unit is configured to generate the image so that a display mode of the image content for the detected road line is constant, and
the display control unit provides the image including the image content for the detected road line to the head-up display and cause the head-up display to display the image.

4. The display control device according to claim 1, wherein
the image generation unit is configured to generate, as the termination notification image, an image including an image content indicating at least one of a remaining time and a remaining distance to the termination of the lane keeping control function.

5. The display control device according to claim 1, wherein
the image generation unit is configured to generate the termination notification image so that an image content indicating an end position of the lane keeping control function is displayed at a position in the traveling lane at which the lane keeping control function is terminated.

6. The display control device according to claim 1, wherein
the image generation unit is configured to generate, as the termination notification image, an image including an image content that urges the driver to hold a steering wheel of the vehicle.

7. The display control device according to claim 6, wherein
the image generation unit is configured to generate, as the termination notification image, the image including the image content that urges the driver to hold the steering wheel even when one of road lines of the traveling lane is undetected while an offset control for offsetting a traveling position of the vehicle within the traveling lane in a direction away from a specific control target is being executed.

8. The display control device according to claim 2, wherein
the image generation unit is configured to generate the image so that the image content for the undetected road line is displayed to blink and the image content for the detected road line is continuously displayed without blinking.

9. The display control device according to claim 2, wherein
the image generation unit is configured to generate the image so that the image content for the undetected road line has a brightness lower than a brightness of the image content for the detected road line.

10. The display control device according to claim 2, wherein
the image generation unit is configured to generate the image so that the image content for the detected road line is displayed in one of inside and outside of the traveling lane.

11. The display control device according to claim 2, wherein
the image generation unit is configured to generate an image that has an undetected position image content at an undetected position at which the road line is no longer detected on the traveling lane, the undetected position image content indicating the undetected position.

12. A display control device for a head-up display of a vehicle, the display control device comprising:
an image generation unit configured to generate an image to be displayed by the head-up display; and
a display control unit configured to provide the image generated by the image generation unit to the head-up display and cause the head-up display to display the image, wherein
in response to an operation of a lane keeping control function that drives the vehicle to travel in a traveling lane being continued when one of road lines on a left side and a right side of the traveling lane is undetected, the image generation unit is configured to generate a continuation notification image for notifying a driver of a continuation of the operation of the lane keeping control function, and
the display control unit is configured to provide the continuation notification image to the head-up display and cause the head-up display to display the continuation notification image.

13. The display control device according to claim 12, wherein
the image generation unit is configured to generate, as the continuation notification image, an image including at least one of an image content for a detected road line indicating a section where road lines on both sides of the traveling lane are detected and an image content for an undetected road line indicating a section where only one of the road lines of the traveling lane is detected, and
the image content for the detected road line and the image content for the undetected road line have different display modes.

14. The display control device according to claim 13, wherein
the image generation unit is configured to generate the continuation notification image including an image content highlighting the road line that is no longer detected and the image content for the detected road line.

15. The display control device according to claim 13, wherein
the image generation unit is configured to generate the continuation notification image including an image content highlighting the road line that is detected again and the image content for the undetected road line.

16. The display control device according to claim 13, wherein
in response to an offset control that offsets a traveling position of the vehicle in a direction away from a specific control target within the traveling lane being executed by the lane keeping control function, the image generation unit is configured to generate the image content for the undetected road line in a display mode different from the detected road line even when one of the road lines is undetected.

17. The display control device according to claim 13, wherein
the image generation unit is configured to generate the image so that the image content for the undetected road line is displayed to blink and the image content for the detected road line is continuously displayed without blinking.

18. The display control device according to claim 13, wherein
the image generation unit is configured to generate the image so that the image content for the undetected road line has a brightness lower than a brightness of the image content for the detected road like.

19. The display control device according to claim 13, wherein
the image generation unit is configured to generate the image so that the image content for the detected road line is displayed in one of inside and outside of the traveling lane.

20. The display control device according to claim 13, wherein
the image generation unit is configured to generate an image that has an undetected position image content at an undetected position at which the road line is no longer detected on the traveling lane, the undetected position image content indicating the undetected position.

21. The display control device according to claim 13, wherein
the image generation unit is configured to generate the image so that the image content for the detected road line is displayed at a position based on an offset amount corresponding to the image content for the detected road line from the detected road line, and the image content for the undetected road line is displayed at a position based on an offset amount corresponding to the image content for the undetected road line from the detected road line.

22. The display control device according to claim 13, wherein
in response to the traveling lane being curved, the image generation unit is configured to generate the image so that the image content for the detected road line and the image content for the undetected road line are drawn at positions closer to a center of the traveling lane with a decrease in a radius curvature of the traveling lane.

23. A display control program product for a head-up display of a vehicle,
the display control program product being stored in a computer-readable non-transitory tangible storage medium, and including instructions to be executed by one or more processors, the instructions comprising:
generating a termination notification image to notify a driver of a termination of a lane keeping control function of driving the vehicle to travel in a traveling lane;
providing the termination notification image to the head-up display; and
causing the head-up display to display the termination notification image.

24. The display control program product according to claim 23, wherein
the instruction of generating the termination notification image is configured to generate, as the termination notification image, an image including (i) an image content for a detected road line to be displayed along a road line of the traveling lane that is continuously detected and (ii) an image content for an undetected road line to be displayed along a road line of the traveling lane that is no longer detected, in response to the lane keeping control function being terminated, wherein
the image content for the detected road line and the image content for the undetected road line have different display modes.

25. The display control program product according to claim 23, wherein
the instruction of generating the termination notification image is configured to generate, as the termination notification image, an image including an image content that urges the driver to hold a steering wheel of the vehicle even when one of road lines of the traveling lane is undetected while an offset control for offsetting a traveling position of the vehicle within the traveling lane in a direction away from a specific control target is being executed.

26. A display control program product for a head-up display of a vehicle,
the display control program product being stored in a computer-readable non-transitory tangible storage medium, and including instructions to be executed by one or more processors, the instructions comprising:
in response to an operation of a lane keeping control function of driving the vehicle to travel in a traveling lane being continued when one of a right road line and a left road line of the traveling lane is undetected, generating a continuation notification image to notify the driver of a continuation of the lane keeping control function;
providing the continuation notification image to the head-up display; and
causing the head-up display to display the continuation notification image.

27. The display control program product according to claim 26, wherein
the instruction of generating the continuation notification image is configured to generate, as the continuation notification image, an image including at least one of an image content for a detected road line indicating a section where road lines on both sides of the traveling lane are detected and an image content for an undetected road line indicating a section where only one of the road lines of the traveling lane is detected, wherein
the image content for the detected road line and the image content for the undetected road line have different display modes.

28. The display control program product according to claim 27, wherein
the instruction of generating the continuation notification image is configured to generate the image content for the undetected road line in a display mode different from the detected road line even when one of the road lines is undetected, in response to an offset control that offsets a traveling position of the vehicle in a direction away from a specific control target within the traveling lane being executed by the lane keeping control function.

29. The display control program product according to claim 27, wherein
the instruction of generating the continuation notification image is configured to generate the image so that the image content for the detected road line is displayed at a position based on an offset amount corresponding to the image content for the detected road line from the detected road line, and the image content for the undetected road line is displayed at a position based on an offset amount corresponding to the image content for the undetected road line from the detected road line.

30. The display control program product according to claim 27, wherein
the instruction of generating the continuation notification image is configured to generate, in response to the traveling lane being curved, the image so that the image content for the detected road line and the image content for the undetected road line are drawn at positions closer to a center of the traveling lane with a decrease in a radius curvature of the traveling lane.
